(19) United States
(12) Patent Application Publication
(10) Pub. No.: US 2015/0051231 A1
(43) Pub. Date: Feb. 19, 2015

(54) SYNERGISTIC COMBINATIONS OF TRIAZOLES, STROBILURINS AND BENZIMIDAZOLES, USES, FORMULATIONS, PRODUCTION PROCESSES AND APPLICATIONS USING THE SAME

(71) Applicants: Luis Donizete Borges, Uberaba (BR); Leandro Anderlin Garcia, Londrina (BR); Carlos Eduardo Fabri, Limeira (BR); Antonio Moreira Lima, Paulinia (BR); Roberta de Fátima de Godoy, Uberaba (BR); Ricardo Camara Werlang, Goiania (BR)

(72) Inventors: Luis Donizete Borges, Uberaba (BR); Leandro Anderlin Garcia, Londrina (BR); Carlos Eduardo Fabri, Limeira (BR); Antonio Moreira Lima, Paulinia (BR); Roberta de Fátima de Godoy, Uberaba (BR); Ricardo Camara Werlang, Goiania (BR)

(73) Assignee: FMC Quimica do Brasil Ltda., Campinas (BR)

(21) Appl. No.: 13/876,613

(22) PCT Filed: Sep. 26, 2011
(86) PCT No.: PCT/BR2011/000346

§ 371 Date: Nov. 5, 2013

(30) Foreign Application Priority Data
Sep. 29, 2010 (BR) PI003373-4

(51) Int. Cl. A01N 43/54; A01N 37/50; A01N 43/80; A01N 43/653; A01N 43/52

(52) U.S. Cl. CPC A01N 43/54; A01N 43/653; A01N 43/52; A01N 43/80; A01N 37/50
USPC 514/269

(57) ABSTRACT

The present invention relates to an agrochemically synergistic formulation of triazoles, strobilurins and benzimidazoles, in specific proportions for controlling and/or combating plagues and diseases caused therefrom in vegetable cultures. Also described are their process of preparation, use and method of use as well as the use of triazoles, strobilurins and benzimidazoles in the preparation of the agrochemically synergistic formulation of the invention.

### BACKGROUND OF THE INVENTION

The present invention relates to a balanced synergistic combination of active ingredients for controlling diseases in soybean, cotton, corn, beans, wheat, rice, potatoes, tomatoes, citrus and coffee.

Fungicide tebuconazole is known by the person skilled in the art for controlling various plant diseases. Patent EP 40 345 provides a description of tebuconazole and some uses. It is a fungicide of the triazole chemical group, and acts by inhibiting the biosynthesis of ergosterol, a substance important for maintaining the integrity of the cell membrane of fungi. Tebuconazole is generally known as (RS)-1-p-chlorophenyl-4,4-dimethyl-3-(1H-1,2,4-triazol-1-ylmethyl)pentan-3-ol and has registration number CAS 107534-96-3. Tebuconazole is described in The Pesticide Manual, page 1072 (entry 808), CDS Thomas, Ed (15 th Ed., 2009).

Flutriafol is a fungicide known by the person skilled in the art for controlling various plant diseases. Patent EP 15 756 provides a description of flutriafol and some uses. It is a fungicide of the triazole chemical group, and acts by inhibiting the biosynthesis of ergosterol, a substance important for maintaining the integrity of the cell membrane of fungi. Flutriafol is generally known as (RS)-2,4′-difluoro-α-(1H-1,2,4-triazol-1-ylmethyl)benzhydryl alcohol and has registration number CAS 76674-21-0. Flutriafol is described in The Pesticide Manual, page 560 (entry 422), CDS Thomas, Ed (15 th Ed., 2009).

Carbendazim is a fungicide known by the person skilled in the art for controlling various plant diseases. A more detailed description with some uses can be seen in document U.S. Pat. No. 3,010,968. It is a fungicide of the benzimidazole chemical group and acts specifically in cell division by inhibiting the biosynthesis of tubulin, which is a protein that makes up microtubules. Thus, the formation of microtubules is distorted and there is no division of the nucleus and consequent separation. Carbendazim is generally known as 2-methoxybenzimidazol-2-yl)carbamic acid and has registration number CAS 10605-21-7 Carbendazim is described in The Pesticide Manual, page 158 (entry 123), CDS Thomas, Ed (15 th Ed., 2009).

Azoxystrobin is a fungicide known by the person skilled in the art for controlling various plant diseases. A more detailed description with some uses can be seen in document EP 382 375. It is a fungicide of the strobilurin chemical group and acts by inhibiting mitochondrial respiration, which blocks the transfer of electrons between cytochrome b and cytochrome c1, at the Qo site, interfering in the production of ATP. Azoxystrobin is generally known as methyl(E)-2-[2-[6-(2-cyanophenoxy)pyrimidin-4-yl]oxyphenyl]-3-ethoxyprop-2-enoate and has registration number CAS 215934-32-0. Azoxystrobin is described in The Pesticide Manual, page 62 (entry 52), CDS Thomas, Ed (15 th Ed., 2009).

Kresoxim-methyl is a fungicide known by the person skilled in the art for controlling various plant diseases. A more detailed description with some uses can be seen in document EP 253 213. It is a fungicide of the strobilurin chemical group and acts by inhibiting mitochondrial respiration, which blocks the transfer of electrons between cytochrome b and cytochrome c1, at the Qo site, interfering in the production of ATP. Kresoxim-methyl is generally known as methyl(E)-methoxyimino[α-(o-tolyloxy)-o-tolyl]acetate and has registration number CAS 143390-89-0. Kresoxim-methyl is described in The Pesticide Manual, page 688 (entry 517), CDS Thomas, Ed (15th Ed., 2009).

The present invention can be practiced to control the following diseases, in the following cultures:

Soybean crop: Cercospora leaf blight (Cercospora kikuchii) American Rust (Phakopsora meibomiae); Asian soybean rust (Phakopsora pachyrhizi); Alternaria leaf spot (Alternaria sp); Brown spot (Septoria glycines); Frogeye leaf spot (Cercospora sojina); Target spot (Corynespora cassiicola); Soybean blight (Rhizoctonia solani); Powdery mildew (Erysiphe diffusa); Anthracnose (Colletotrichum dematium var. Truncata) White stem rot (Sclerotinia sclerotiorum).

Cotton crop: Boll rot (Colletotrichum gossypii var. Cephalosporioides); Ramularia (Ramularia areola); Alternaria leaf spot (Alternaria sp); Myrothecium leaf spot (Myrothecium roridum) Rust (Phakopsora gossypii) (Puccinia cacabata).

Corn crop: Northern corn leaf blight (Exerohilum turcicum); White spot or phaeosphaeria leaf spot (Phaeosphaeria maydis); Diplodia leaf spot (Diplodia macrospora); Gray leaf spot (Cercospora zea-maydis); Anthracnose (Colletotrichum graminicola); Southern rust (Puccinia polysora); Tropical rust (Physopella zeae); Common rust (Puccinia sorghi).

Beans crop: Blight (Phaeoisariopsis griseola); Anthracnose (Colletotrichum lindemuthianum); White mold (Sclerotinia sclerotiorum); Powdery mildew (Erysiphe polygons); Rust (Uromyces appendiculatus).

Wheat crop: Stem rust (Puccinia graminis); Yellow spot (Drechslera tritici-repentis); Helminthosporiosis (Bipolaris sorokiniana); Leaf rust (Puccinia triticina); Blast (Pyricularia grisea); Powdery mildew (Blumeria graminis); Septoria (Septoria tritici).

Rice crop: Blast (Pyricularia grisea); Brown spot (Bipolaris oryzae).

Potato crop: Alternaria leaf spot (Alternaria solani).

Tomato crop: Alternaria leaf spot (Alternaria solani); septoria (Septoria lycopersici).

Citrus crop: Anthracnose (Colletotrichum gloeosporioides); Alternaria leaf spot (Alternaria citri); Citrus scab (Elsinoe fawcett).

Coffee crop: Rust (Hemileia vastatrix); Cercosporiosis (Cercospora coffeicola); Anthracnose (Colletotrichum coffeanum); Ascochyta (Ascochyta coffeae); Phoma leaf spot (Phoma spp.)

Diseases in plants cause considerable losses in agricultural crops, both by reducing the production capacity and causing direct damage decreasing the commercial value of fruits, grains or tubers. The percentage of losses in crops due to diseases is reported in the literature by researchers studying diseases in major tropical crops: Sugar cane, 20-30%; banana, 20-29%; wheat, 10-12%; orange 28-34%; corn, 20-23%; beans, 20-35%; sorghum, 25-35%; rice, 35-50%; tobacco, 17-25%; potato, 20-30%; tomato, 35-50%; pastures, 17-30%; coffee, 20-27%; cotton, 15-70%; soybean, 10-85%, and cocoa 27-35%. The adoption of management practices is a very important component in the production system. Within the management tools, the use of fungicides is necessary because of the need to reduce the pathogen population, as well as inhibit its development.

Among the more than 250 cotton pathogens recorded in the literature, Cia & Fuzatto (1999) report about 30 of them occurring in Brazil. Of these, except for seedling pathogens and others of very recent occurrence, about 10 could be considered of primary importance to the cotton culture in the country.

The regional importance of each pathogen varies considerably. Overall, traditional growing regions have a higher number, while new regions have a restricted number of diseases, gradually incorporating new problems over the years. The spread and evolution of regional diseases result mainly from prevailing regional attitudes and treatments. A series of factors governs the introduction and the dynamics of pathogens in a given medium: proximity and exchange with other producing regions (countries), regional physiographic characteristics, prevention, cultural measures, soil management, utilization rate of seeds and degree of resistance of cvs. used are the main ones.

The main foliar diseases of cotton in Brazil are: Boll rot (Colletotrichum gossypii var. Cephalosporioides); Ramularia (Ramularia areola Atk.); Alternaria leaf spot (Alternaria sp); Myrothecium leaf spot (Myrothecium roridum); Rust (Phakopsora gossypii) (Puccinia cacabata).

Corn (Zea mays L.) is also a very important crop in Brazilian agriculture. Its yield can be influenced by such factors as water availability, soil fertility, plant population, crop system, the productive potential of the hybrid and management of weeds, pests and diseases.

In Brazil, many diseases are reported in corn crops, and recently the most common ones are related to stalk and ear rot and leaf diseases caused by fungi. In the high technology production system, foliar diseases have received increased importance since the materials with higher yield potential have shown more sensitivity to these diseases. Thus, managing the use of foliar fungicides is providing productivity gains in this culture.

The stalk rot consist of stem tissue rot evident when plants are close to harvest. Damage is attributed to interruption of the normal grain filling, lodging of plants and premature death of the plant at the end of the cycle. In Brazil, fungi Colletotrichum graminicola (Ces) GW Wils., Stenocarpella maydis (Berk.) Sutton [Sin. Diplodia maydis (Berk.) Sacc., S. macrospora (Earle) Sutton [Sin. D. macrospora Earle in Bull.] Fusarium graminearum Schwabe (Gibberella zeae Schw.) and Fusarium verticillioides [Sin.=Fusarium moniliforme J. Sheld (Gibberella fujikuroi Sawada)] are cited as major causative agents of stalk rot (Pereira, 1997, Pinto et al., 1997).

With the exception of C. graminicola, the other fungi mentioned above commonly cause ear rot (Pinto et al., 1997), and are often isolated from the seeds of maize (Casa et al. 1998; Pinto, 1998). In the field, infected grains may exhibit symptoms of discoloration. So rotten cobs reduce grain yield and grain quality, because a percentage relative to the incidence of ear rot is discounted from the trade price. Also in the case of ear rot data to quantify damage is scarce and inaccurate.

The main leaf spots are the Northern corn leaf blight caused by the fungus Exerohilum turcicum (Pass.) Leonar & Suggs, the white leaf spot or phaeosphaeria, caused by Phaeosphaeria maydis (P. Henn.) Rae, Payak & Renfro, and diplodia spot, caused by S. macrospora. Currently in Brazil, the gray leaf spot, caused by the fungus Cercospora zea-maydis Tenhon & Daniels, stands out, first recorded in the country by Viégas and Krug in 1934, in Campinas, São Paulo (Viégas, 1945). Since then, the disease has virtually ceased to be observed in our country or there was no report of an epidemics. However, in the second crop of maize in 2000 in southwest Goiás, the disease resurfaced causing devastating effects, destroying all the healthy leaf area of plants and, in a short period of time, eventually killing the plants early. Other important diseases in corn that have caused losses in the commercial areas are: Anthracnose (Colletotrichum graminicola); Southern rust (Puccinia polysora); Tropical rust (Physopella zeae); Common rust (Puccinia sorghi).

Diseases are major constraints to achieving high yields in soybean crops. Approximately 40 diseases caused by fungi, bacteria, nematodes and viruses have been identified in Brazil. This number continues to increase with the expansion of soybean crops into new areas and as a result of monoculture. The economic importance of each disease varies from year to year and from region to region, depending on climatic conditions of each crop. The annual production losses due to diseases are estimated at about 15% to 20%, but some diseases can cause loss of almost 100%.

The following soybean diseases have been identified in Brazil. Their occurrence can vary from sporadic or restricted to widespread incidence nationally. Leaf diseases: Cercospora leaf blight (Cercospora kikuchii) American rust (Phakopsora meibomiae); Asian soybean rust (Phakopsora pachyrhizi); Alternaria leaf spot (Alternaria sp); Ascochyta blight (Ascochyta sojae); Myrothecium leaf spot (Myrothecium roridum); Brown spot (Septoria glycines); Frogeye spot (Cercospora sojina); Downy mildew (Peronospora manshurica); Phyllosticta spot (Phyllosticta sojicola); Target spot (Corynespora cassiicola); Soybean blight (Rhizoctonia solani); Powdery mildew (Erysiphe diffusa). Diseases of the stem, pod and seed: Anthracnose (Colletotrichum dematium var. truncata); Stem canker (Diaporthe phaseolorum f.sp. meridionalis); Purple stain (Cercospora kikuchii); Pod and stem blight (Phomopsis spp.) Pod blight (Fusarium spp.) Yeast spot (Nematospora corily); White stem rot (Sclerotinia sclerotiorum), and other root diseases, bacterial diseases, diseases caused by viruses, diseases caused by nematodes and diseases of unknown causes.

Among the entire complex of soybean diseases, Asian soybean rust deserves special attention due to its high virulence and infection potential, area of occurrence, aggressiveness and high rate of spread. The Asian soybean rust caused by Phakopsora pachyrhizi Sydow has caused significant damage in soybean crops. According to Caldwell & Laing (2005), the inoculum reached the African continent carried by air currents. In South America, it was first described by Morel (2001) in Paraguay, followed by Brazil, Yorinori (2002), Uruguay, Argentina and Bolivia. The damage in the yield has varied between 10 and 85%, mainly in areas where control is not executed or is delayed.

Symptoms are particularly evident in the leaves, from isolated uredia to areas with significant coalescence when it causes yellowing and premature leaf abscission. Damages are grouped into brown coloration with two to five uredias and abundant sporulation (B) or the formation of reddish-brown lesions, with zero to two uredias and sparse sporulation (PA) (Bromfield, 1984).

Prolonged leaf wetness (10 h/day), night temperature between 18 and 24° C. and frequent rains are determining conditions for establishing the disease. The spread of the disease has occurred at a rate exceeding 1 m/day (Soybean Research Meeting, Southern Region, 2002.). According to Bromfield (1984), infections at flowering produce high levels of damage, also affecting the protein content in the grain (Ogle et al., 1979).

Fungicides applied preventively have proven to be the most effective strategy in controlling this disease (Azevedo, 2001; Hartman et al., 1991). Greater residual period and better performance of the fungicides were obtained by Vitti et al. (2004), due to the preventive application of fungicides. Likewise, Oliveira (2004) found an increase in yield up to 100% when disease control was preventively performed.

Until the 2005/06 harvest, the fungus was effectively controlled by the use of fungicides, especially triazoles alone or in combination with the strobilurins (Silva et al., 2006). However, from the 2005/06 harvest on, there were control failures in some regions in Mato Grosso, which were treated with the triazole flutriafol. In this crop, no problems were found in Goiás (Silva et al., 2008a).

From the 2006/07 harvest on, problems in the efficacy of the triazoles, even in preventive applications, were found in experiments carried out by Silva et al. (2008b). For these authors, the problems have been verified not only for flutriafol, but also for the other triazoles, such as tebuconazole and cyproconazole.

In the 2008/09 harvest, problems were also observed for mixtures (strobilurins+triazoles), when used in a curative manner under high pressure (unpublished data). This was expected since they possess triazoles in their composition, and the benefit of the strobilurin is known to be preventive.

In the 2007/2008 harvest, a lower efficiency of tebuconazole was observed on tests performed in late sowing (Godoy, 2009). This lower efficiency has been associated with the selection of populations of fungi less sensitive to triazoles, throughout harvest, as demonstrated by monitoring the sensitivity of the fungi carried out since 2005, by Bayer CropScience (Mehl, 2009).

There are several classification criteria for fungicides. The classification is usually based on the chemical nature and mode of action of the product. The classification based on the mode of action is: protective with contact action; contact with eradicative action; systemic with systemic and eradicative action; penetrating with depth action and resistance inducers. As for the resistance inducers, there is scant evidence.

The protective fungicides prevent the successful penetration of fungi in the host tissue. Among the fungicides available for soybean rust management, the class of strobilurin fungicides (azoxystrobin, pyraclostrobin, trifloxystrobin, etc.) has the ability to interrupt spore germination and penetration in the host. However, it has little or no effect after the fungus has penetrated or colonized the host plant tissue.

The curative fungicides have the ability to inhibit or stop the development of infections that have already begun. Some fungicides act by inhibiting sporulation which helps to slow down the development of the disease, limiting the reproductive potential of the fungus. Among the fungicides available for soybean rust management, only the triazoles have some curative activity. It is this activity of triazoles that provides limited curative effect in low levels of rust in the field. If one of the strobilurin fungicides is applied after infection, they will continue to develop. It is very important to remember that the triazoles have limited curative action. This is the main reason why fungicides are not effective in controlling soybean rust, in conditions of high or moderate disease pressure in the field.

The mobility of fungicides is differentiated. The main point is that different fungicides, even those in the same chemical class, are not necessarily equal when it comes to mobility within the plant. Systemic fungicides, such as triazoles, benzimidazoles and strobilurins, are absorbed by plants and redistributed into the tissues at different levels of mobility.

All strobilurin fungicides are absorbed and have translaminar translocation, but differences in the systemic circulation have been observed between different strobilurins. For instance, pyraclostrobin is a strobilurin that has less mobility than azoxystrobin, which is absorbed by the plant, but it does not move much beyond the absorption point. Regardless of strobilurin, the leaves produced after application are not protected adequately. The triazole fungicides have systemic activity and as a group they tend to be more quickly absorbed and redistributed within the leaf and up (via xylem) for the new developing leaves.

A major concern in the association of fungicides is to make use of all the benefits of the molecules employed, such as mode of action of each molecule, differentiated systematicity and stages in which the fungicide provides pathogen control. Thus, the association of fungicides that have different modes of action and that are at different stages of the pathogen has better potential to control plant diseases, which can further result in better residual control.

One of the concerns associated with the group of strobilurin fungicides and to a lesser extent with the triazoles is the potential to develop resistance in populations of fungi such as Phakopsora pachyrhizi exposed to these fungicides. Resistance to strobilurin fungicides has already been reported in several pathogens, since the mode of action is very specific, occurrence of resistance is facilitated in a manner similar to the benzimidazoles. As for the triazoles, there are also several reports of resistant pathogens. However, the potential emergence of resistance is smaller than for strobilurins.

The association of fungicide molecules with different modes of action is an important tool in the management of plant diseases as well as the efficacy and residual control and the sustainability of the control tools by imposing difficulties in the emergence of resistance, in addition to the possibility of causing a synergistic effect in the interactions.

### SUMMARY OF THE INVENTION

The present invention relates to a synergistic combination of triazoles, strobilurins and benzimidazoles.

Particularly, it is an object of the invention to provide synergistic combinations of molecules of triazole, strobilurin and benzimidazole fungicides for the control of foliar diseases in plants, these fungicides having different modes of action. In a particularity of the invention, such combinations include: tebuconazole+carbendazim+azoxystrobin; tebuconazole+carbendazim+kresoxim-methyl; flutriafol+carbendazim+azoxystrobin; flutriafol+carbendazim+kresoxim-methyl.

Another object of the invention is to provide a product with the interaction of three fungicides, wherein the combination of fungicide molecules meets the following ratios: tebuconazole (25 to 250 g/L); carbendazim (50 to 500 g/L), azoxystrobin (5 to 200 g/L), with the possibility of the interaction of fungicide molecules meeting these ratios, which results in products with high efficacy in controlling plant diseases.

Another objective of the invention is to provide a balanced, synergistic combination of specific (pre-mix) at a concentration of tebuconazole (100 g/L ai, ai=active ingredient)+carbendazim (200 g/L ai)+azoxystrobin (30 g/L ai), coded as “BF 488” for controlling a broad spectrum of diseases in soybean, cotton, corn, beans, wheat, rice, potato, tomato, citrus and coffee crops.

Another objective of the invention is to reduce the amount of active ingredient per hectare, since the synergism of the molecules of the present invention BF 488 (tebuconazole+carbendazim+azoxystrobin) provides application of smaller amounts of actives per ha of carbendazim and azoxystrobin.

Another important factor of the invention is to increase the residual effect of the fungicides in product BF 488, compared with tebuconazole applied alone or with azoxystrobin applied alone, this prolonged effect resulting in greater efficacy in controlling diseases.

Another important factor of the invention is to increase the spectrum of disease control in crops with the application of product BF 488 (tebuconazole+carbendazim+azoxystrobin), with no need to mix the products in the spray tank and to have the immediate re-entry in the area with another product. This fact is a function of the synergistic association of three modes of action of fungicides, the triazoles—which are highly effective in controlling Ascomycetes and Basidiomycetes, and have some action in Deuteromycetes; the benzimidazoles—which are highly effective in controlling Deuteromycetes and have some action in controlling Ascomycetes and Basidiomycetes; and strobilurins—which are highly effective in controlling Deuteromycetes and have some action in controlling Oomycetes and Basidiomycetes and have little activity in Ascomycetes.

Another important factor of the invention referring to product BF 488 (tebuconazole+carbendazim+azoxystrobin) will be an important tool in the management of disease resistance to fungicides, being a mixture of three different active chemical groups and modes of action.

Another object of the invention is to provide a product with the interaction of three fungicides, coded as “BF 452”, wherein the combination of fungicide molecules meets the following ratios: tebuconazole (25 to 250 g/L); carbendazim (50 to 500 g/L), kresoxim-methyl (50 a 500 g/L), with the possibility of the interaction of fungicide molecules meeting these ratios, which results in products with high efficacy in controlling plant diseases.

The specific combination of BF 452 is a balanced and synergistic (pre-mix), particularly having the concentration of tebuconazole (100 g/L ai)+carbendazim (200 g/L ai)+kresoxim-methyl (125 g/L ai), for controlling a broad spectrum of diseases in soybean, cotton, corn, beans, wheat, rice, potato, tomato, citrus and coffee crops.

Another objective of the invention is to reduce the amount of active ingredient per hectare, since the synergism of the molecules of the present invention BF 452 (tebuconazole+carbendazim+kresoxim-methyl) provides the application of smaller amounts of actives per ha of carbendazim and kresoxim-methyl.

Another important factor of the invention is to increase the residual effect of the fungicides in product BF 452, compared with tebuconazole applied alone or with kresoxim-methyl applied alone, this prolonged effect resulting in greater efficacy in controlling diseases.

Another important factor of the invention is to increase the spectrum of disease control in crops with the application of product BF 452 (tebuconazole+carbendazim+kresoxim-methyl), with no need to mix the products in the spray tank and to have the immediate re-entry in the area with another product. This fact is a function of the synergistic association of three modes of action of fungicides, the triazoles—which are highly effective in controlling Ascomycetes and Basidiomycetes, and have some action in Deuteromycetes; the benzimidazoles—which are highly effective in controlling Deuteromycetes and have some action in controlling Ascomycetes and Basidiomycetes; and strobilurins—which are highly effective in controlling Deuteromycetes and have some action in controlling Oomycetes and Basidiomycetes and have little activity in Ascomycetes.

Another important factor of the invention referring to product BF 452 (tebuconazole+carbendazim+kresoxim-methyl) will be an important tool in the management of disease resistance to fungicides, being a mixture of three different active chemical groups and modes of action.

Another object of the invention is to provide a product with the interaction of three fungicides, coded as “BF 452”, wherein the combination of fungicide molecules meets the following ratios: flutriafol (25 to 250 g/L); carbendazim (50 to 500 g/L), azoxystrobin (5 to 200 g/L), with the possibility of the interaction of fungicide molecules meeting these ratios, which results in products with high efficacy in controlling plant diseases.

The specific combination of BF 489 is a balanced and synergistic (pre-mix), particularly having the concentration of flutriafol (63 g/L ai)+carbendazim (200 g/L ai)+azoxystrobin (30 g/L ai), for controlling a broad spectrum of diseases in soybean, cotton, corn, beans, wheat, rice, potato, tomato, citrus and coffee crops.

Another objective of the invention is to reduce the amount of active ingredient per hectare, since the synergism of the molecules of the present invention BF 489 (flutriafol+carbendazim+azoxystrobin) provides application of smaller amounts of actives per ha of carbendazim and azoxystrobin.

Another important factor of the invention is to increase the residual effect of the fungicide product BF 489, compared with flutriafol applied alone or with azoxystrobin applied alone, this prolonged effect resulting in greater efficacy in controlling diseases.

Another important factor of the invention is to increase the spectrum of disease control in crops with the application of product BF 489 (flutriafol+carbendazim+azoxystrobin), with no need to mix the products in the spray tank and to have immediate re-entry in the area with another product. This fact is a function of the synergistic association of three modes of action of fungicides, the triazoles—which are highly effective in controlling Ascomycetes and Basidiomycetes, and have some action in Deuteromycetes; the benzimidazoles—which are highly effective in controlling Deuteromycetes and have some action in controlling Ascomycetes and Basidiomycetes; and strobilurins—which are highly effective in controlling Deuteromycetes and have some action in controlling Oomycetes and Basidiomycetes and have little activity in Ascomycetes.

Another important factor of the invention referring to product BF 489 (flutriafol+carbendazim+azoxystrobin) will be an important tool in the management of disease resistance to fungicides, being a mixture of three different active chemical groups and modes of action.

Another object of the invention is to provide a product with the interaction of three fungicides, coded as “BF 465”, wherein the combination of fungicide molecules meets the following ratios: flutriafol (25 to 250 g/L); carbendazim (50 to 500 g/L), kresoxim-methyl (50 a 500 g/L), with the possibility of the interaction of fungicide molecules meeting these ratios, which results in products with high efficacy in controlling plant diseases.

The specific combination of BF 465 is a balanced and synergistic (pre-mix), particularly having the concentration of flutriafol (63 g/L ai)+carbendazim (200 g/L ai)+kresoxim-methyl (125 g/L ai), for controlling a broad spectrum of diseases in soybean, cotton, corn, beans, wheat, rice, potato, tomato, citrus and coffee crops.

Another objective of the invention is to reduce the amount of active ingredient per hectare, since the synergism of the molecules of the present invention BF 465 (flutriafol+carbendazim+kresoxim-methyl) provides application of smaller amounts of actives per ha of carbendazim and kresoxim-methyl.

Another important factor of the invention is to increase the residual effect of the fungicide product BF 465, compared with flutriafol applied alone or with kresoxim-methyl applied alone, this prolonged effect resulting in greater efficacy in controlling diseases.

Another important factor of the invention is to increase the spectrum of disease control in crops with the application of the product BF 465 (flutriafol+carbendazim+kresoxim-methyl), with no need to mix the products in the spray tank and to have the immediate re-entry in the area with another product. This fact is a function of the synergistic association of three modes of action of fungicides, the triazoles—which are highly effective in controlling Ascomycetes and Basidiomycetes, and have some action in controlling Deuteromycetes; the benzimidazoles—which are highly effective in controlling Deuteromycetes and have some action in controlling Ascomycetes and Basidiomycetes; and strobilurins—which are highly effective in controlling Deuteromycetes and have some action in controlling Oomycetes and Basidiomycetes and have little activity in Ascomycetes.

Another important factor of the invention referring to product BF 465 (flutriafol+carbendazim+kresoxim-methyl) will be an important tool in the management of disease resistance to fungicides, being a mixture of three different active chemical groups and modes of action.

### DETAILED DESCRIPTION OF THE INVENTION

The present invention relates to a solid or liquid formulation, wherein, in the solid form, it is suitable as wettable powder type (WP) and/or water-dispersible granules (WDG) and, in the liquid form, it is suitable as emulsifiable concentrate (EC), suspension concentrate (SC), suspo-emulsion (SE) and/or concentrated emulsion (EW), preferably as SC, but not excluding other types of formulations.

The formulations comprise the mixture of chemical groups benzimidazole, triazole and strobilurin. The active ingredients and their proportions are shown below.

For product BF488, the ratio of the amount of Carbendazim, Tebuconazole and Azoxystrobin is 10 to 30 parts of Carbendazim, 5 to 15 parts of Tebuconazole and 1 to 5 parts of Azoxystrobin, and, in a particularity of the invention, the optimum ratio is 20:10:3, respectively.

For product BF489, the ratio of the amount of Carbendazim, Flutriafol and Azoxystrobin is 10 to 30 parts of Carbendazim, 4 to 8 parts of Flutriafol and 1 to 5 parts of Azoxystrobin, and, in a particularity of the invention, the optimum ratio is 20:6.25:3, respectively.

For product BF452, the ratio of the amount of Carbendazim, Tebuconazole and Krezoxim-Methyl is 10 to 30 parts of Carbendazim, 5 to 15 parts of Tebuconazole and 6 to 18 parts of Krezoxim-Methyl, and, in a particularity of the invention, the optimum ratio is 20:10:12.5, respectively.

For product BF465, the ratio of the amount of Carbendazim, Flutriafol and Krezoxim-Methyl is 10 to 30 parts of Carbendazim, 4 to 8 parts of Flutriafol and 6 to 18 parts of Krezoxim-Methyl, and, in a particularity of the invention, the optimum ratio is 20:6.55:12.5, respectively.

The concentration of the sum of the active ingredients in the final formulation can vary, typically between about 10 gai/L to about 700 gai/L (gai=gram of active ingredient). The remainder of the composition, up to 1 (one) liter, if liquid, or 1 (one) kilogram, if solid, can be comprised of a suitable carrier and/or excipients, which can be selected from the group consisting of surfactants, defoamers, rheology modifying agents, dispersants, humectants, bactericides or bacteriostatic agents, anti-caking agents, stabilizing agents, antifreezing agents, among others, and the mixture thereof.

The vehicle might normally be inert, made of organic or inorganic material, natural or synthetic. The carrier, if solid, can be clay, silicates, silica, resins, waxes, cellulose fibers, fertilizers or the like, and might be used alone or in combination. If liquid, the carrier can be water, C1 to C14 alcohols, glycols, acetates, ketones, glycerids, saturated or unsaturated hydrocarbons, fatty acid esters, vegetable oils, mineral oils, or the like, and might be used alone or in combination. Preferably, water is used as vehicle.

The surfactants can be either of ionic, non-ionic, cationic or polymeric type.

Anionic surfactants that can be used in this invention could be: dodecylbenzene sulphonic acid, linear or branched, under the acid or neutralized form, nitrogenous derivates, sulfonated aromatic polymers under the acid or neutralized form, sulphonated naphthalene formaldehydes under the acid or neutralized form, condensed or not, lignosulfonates, alkyl-phenol phosphate under the acid or neutralized form. Being these, preferably, ethoxylated tristyryl-phenol-phosphate or not under the acid or neutralized form and the lignosulfonates.

Non-ionic surfactants that can be used in this invention could be: Alkoxylates like alkoxylated sorbitan esters, alkoxylated alcohols, alkoxylated vegetable oils, alkoxylated fatty acids, among others; fatty esters like polyethylene glycol esters, glycerol or polyglycerol esters, sorbitan esters; amides, like fatty acid amide of ethanolamine or ethylene amines, fatty imidazolines, among others. Preferably, alkoxylated alcohols with capric, caprylic, isodecylic, isotridecylic, decylic, lauric, stearylic, oleic, nonyl phenylic chains, with alkoxylation degree of 1 to 16 moles of ethene oxide and/or propene oxide, are used; alkoxylated vegetable oils like alkoxylated castor bean oil with alkoxylation degree between 5 and 54 moles of ethene oxide or propene oxide; alkoxylated sorbitan esters with alkoxylation degree between 5 and 80 moles of ethene oxide and/or propene oxide.

Cationic surfactants that can be used in this invention are alkyl trimethyl ammonium hydrochlorides, dialkyl dimethyl ammonium hydrochloride, alkyl hydroxyethyl dimethyl ammonium hydrochloride, cetyl trimethyl ammonium hydrochloride, distearyl dimethyl ammonium hydrochloride, quaternary esters, among others.

Polymeric surfactants that can be used in this invention are ethene oxide and propene oxide block copolymers, mainly those with butylic chain, polyacrylate copolymers, methyl methacrylate copolymers, among others.

The present invention also relates to a process for preparing the formulations, such as, for instance, the Concentrated Suspension formulation, which includes the following steps:
(i) In a container, mix the water, the surfactants and the additives;
(ii) Add to this mixture, under agitation, the active ingredients the chemical groups of which are Benzimidazole, Triazole and Strobilurin;
(iii) After all raw materials have been added, the formulation is dispersed and undergoes a grinding process, in which there will be more interaction among molecules and reduction of active ingredients particle size, thus increasing the synergism between molecules and their efficacy in the field; and
(iv) After grinding, the formulation undergoes a process of deaeration and densification to increase its physical stability, then obtaining a stable and synergetic agrochemical formulation.

The synergistic agrochemical formulations obtained above are then packed or wrapped in packages commonly used in the art.

A further embodiment of the invention is the use of benzimidazole, triazole e strobilurin in the preparation of formulations to control and/or combat pests and diseases in vegetable crops.

The invention also comprises the use of the formulations of the invention in controlling and/or combating plagues and diseases in vegetable cultures.

Another embodiment of the invention is a method of controlling and/or combating plagues and diseases in vegetable cultures, comprising the application of the formulations of the invention on these plagues, their habitats and/or vegetable cultures.

As previously mentioned, the invention has wide and effective applicability in vegetable cultures of soybean, cotton, corn, beans, wheat, rice, potato, tomato, citrus and coffee, among others, in controlling and combating plagues caused by Alternaria citri, Alternaria solani, Alternaria sp, Ascochyta coffeae, Ascochyta sojae, Bipolaris oryzae, Bipolaris sorokiniana, Blumeria graminis, Cercospora coffeicola, Cercospora kikuchii, Cercospora sojina, Cercospora zea-maydis, Colletotrichum coffeanum, Colletotrichum dematium var. truncata, Colletotrichum gloeosporioides, Colletotrichum gossypii var. cephalosporioides, Colletotrichum graminicola, Colletotrichum lindemuthianum, Corynespora cassiicola, Diaporthe phaseolorum f.sp. meridionalis, Diplodia macrospora, Drechslera tritici-repentis, Elsinoe fawcetti, Erysiphe diffusa, Erysiphe polygoni, Exerohilum turcicum, Hemileia vastatrix, Myrothecium roridum, Peronospora manshurica, Phaeoisariopsis griseola, Phaeosphaeria maydis, Phakopsora gossypii, Phakopsora meibomiae, Phakopsora pachyrhizi, Phoma spp., Phomopsis spp., Phyllosticta sojicola, Physopella zeae, Puccinia cacabata, Puccinia graminis, Puccinia polysora, Puccinia sorghi, Puccinia triticina, Pyricularia grisea, Ramularia areola, S. macrospora, Scierotinia scierotiorum, Septoria glycines, Septoria lycopersici, Septoria tritici, Stenocarpella maydis, Uromyces appendiculatus, without limitation, and diseases caused by the same.

The formulations of the invention are employed in a single, sequential or simultaneous application.

For better understanding purposes, some examples of the formulations used with the present invention are described below, said examples having the intention of exemplifying and not limiting the invention.

### EXAMPLES

### Example 1

### Formulation of the Invention (BF488)

| (Components) | concentration (g/100 mL mL)] |
|---|---|
| Water | qsp |
| Silicon emulsion | 0.3 |
| EO/PO Copolymer | 4 |
| Polyalkylene glycol copolymer | 1.5 |
| with polyolefin with anhydrous | |
| Benzisotiazolin | 0.25 |
| Smectite clay | 0.35 |
| Monoethylene glycol | 7 |
| Xanthan gum | 0.25 |
| Carbendazim | 20 |
| Tebuconazole | 10 |
| Azoxystrobin | 3 |

### Example 2

### Formulation of the Invention (BF488)

| (Components) | [concentration (g/100 mL mL)] |
|---|---|
| Water | qsp |
| Silicon emulsion | 0.3 |
| EO/PO Copolymer | 3 |
| Lignosulfonate | 2 |
| Isotridecyl alcohol with 12 moles | 1 |
| of ethene oxide | |
| Benzisotiazolin | 0.25 |
| Smectite clay | 0.35 |
| Propylenoglycol | 5 |
| Xanthan gum | 0.25 |
| Carbendazim | 20 |
| Tebuconazole | 10 |
| Azoxystrobin | 3 |

### Example 3

### Formulation of the Invention (BF488)

| (Components) | [concentration (g/100 mL mL)] |
|---|---|
| Water | qsp |
| Silicon emulsion | 0.3 |
| Tristyrylphenol phosphate with 16 moles | 3 |
| of neutralized ethene oxide | |
| Tristyrylphenol phosphate with 16 moles | 2 |
| of ethene oxide under the acid form | |
| Isotridecyl alcohol with 12 moles of | 1 |
| ethene oxide | |
| Benzisotiazolin | 0.25 |
| Smectite clay | 0.35 |
| Monoethylene glycol | 5 |
| Xanthan gum | 0.25 |
| Carbendazim | 20 |
| Tebuconazole | 10 |
| Azoxystrobin | 3 |

### Example 4

### Formulation of the Invention (BF488)

| (Components) | [concentration (g/100 mL mL)] |
|---|---|
| Water | qsp |
| Silicon emulsion | 0.3 |
| Tristyrylphenol phosphate with 16 moles | 4.5 |
| of neutralized ethene oxide | |
| Nonylphenol with 10 moles of ethene | 1.7 |
| oxide | |
| Benzisotiazolin | 0.25 |
| Bentonite clay | 0.35 |
| Monoethylene glycol | 8.8 |
| Xanthan gum | 0.25 |
| Carbendazim | 20 |
| Tebuconazole | 10 |
| Azoxystrobin | 3 |

### Example 5

### Formulation of the Invention (BF489)

| (Components) | [concentration (g/100 mL mL)] |
|---|---|
| Water | qsp |
| Silicon emulsion | 0.3 |
| Tristyrylphenol phosphate with 16 moles | 4 |
| of neutralized ethene oxide | |
| Isotridecyl alcohol with 12 moles of | 1.5 |
| ethene oxide | |
| Benzisotiazolin | 0.25 |
| Bentonite clay | 0.35 |
| Monoethylene glycol | 5 |
| Xanthan gum | 0.25 |
| Carbendazim | 20 |
| Flutriafol | 6.25 |
| Azoxystrobin | 3 |

### Example 6

### Formulation of the Invention (BF489)

| (Components) | [concentration (g/100 mL mL)] |
|---|---|
| Water | qsp |
| Silicon emulsion | 0.3 |
| Silicon emulsion | 4 |
| Acrylic copolymer | 1.5 |
| Benzisotiazolin | 0.25 |
| Bentonite clay | 0.35 |
| Monoethylene glycol | 5 |
| Xanthan gum | 0.25 |
| Carbendazim | 20 |
| Flutriafol | 6.25 |
| Azoxystrobin | 3 |

### Example 7

### Formulation of the Invention (BF489)

| (Components) | [concentration (g/100 mL mL)] |
|---|---|
| Water | qsp |
| Silicon emulsion | 0.3 |
| Block copolymer of ethene | 4 |
| oxide and propene oxide | |
| Methyl metacrylate copolymer | 1.5 |
| Benzisotiazolin | 0.25 |
| Bentonite clay | 0.35 |
| Monoethylene glycol | 5 |
| Xanthan gum | 0.25 |
| Carbendazim | 20 |
| Flutriafol | 6.25 |
| Azoxystrobin | 3 |

### Example 8

### Formulation of the Invention (BF489)

| (Components) | [concentration(g/100 mL mL)] |
|---|---|
| Water | qsp |
| Silicon emulsion | 0.3 |
| Tristyrylphenol phosphate with 16 | 4.5 |
| moles of neutralized ethene oxide | |
| Ethoxylated nonylphenol with 10 | 1.5 |
| moles of ethene oxide | |
| Benzisotiazolin | 0.25 |
| Bentonite clay | 0.35 |
| Monoethylene glycol | 9 |
| Xanthan gum | 0.25 |
| Carbendazim | 20 |
| Flutriafol | 6.25 |
| Azoxystrobin | 3 |

### Example 9

### Formulation of the Invention (BF465)

| (Components) | [concentration(g/100 mL mL)] |
|---|---|
| Water | qsp |
| Polydimethylsiloxane | 0.2 |
| Tristyrylphenol phosphate with 16 | 3.0 |
| moles of neutralized ethene oxide | |
| Ethoxylated isotridecyl alcohol | 1.0 |
| with 6 moles of ethene oxide | |
| Benzisotiazolin | 0.25 |
| Monoethylene glycol | 5.0 |
| Xanthan gum | 0.35 |
| Carbendazim | 20 |
| Flutriafol | 6.25 |
| Krezoxim-methyl | 12.5 |

### Example 10

### Formulation of the Invention (BF465)

| (Components) | [concentration (g/100 mL mL)] |
|---|---|
| Water | qsp |
| Polydimethylsiloxane | 0.2 |
| Block copolymer of ethene | 3.0 |
| oxide and propene oxide | |
| Acrylic Copolymer | 1.0 |
| Benzisotiazolin | 0.25 |
| Monoethylene glycol | 5.0 |
| Xanthan gum | 0.35 |
| Carbendazim | 20 |
| Flutriafol | 6.25 |
| Krezoxim-methyl | 12.5 |

### Example 11

### Formulation of the Invention (BF465)

| (Components) | [concentration (g/100 mL mL)] |
|---|---|
| Water | qsp |
| Polydimethylsiloxane | 0.2 |
| Block copolymer of ethene | 3.0 |
| oxide and propene oxide | |
| Methyl metacrylate copolymer | 1.0 |
| Benzisotiazolin | 0.25 |
| Monoethylene glycol | 5.0 |
| Xanthan gum | 0.35 |
| Carbendazim | 20 |
| Flutriafol | 6.25 |
| Krezoxim-methyl | 12.5 |

### Example 12

### Formulation of the Invention (BF452)

| (Components) | [concentration (g/100 mL mL)] |
|---|---|
| Water | qsp |
| Polydimethylsiloxane | 0.2 |
| Block copolymer of ethene | 3.0 |
| oxide and propene oxide | |
| Methyl metacrylate copolymer | 1.0 |
| Benzisotiazolin | 0.25 |
| Monoethylene glycol | 5.0 |
| Xanthan gum | 0.35 |
| Carbendazim | 20 |
| Tebuconazole | 10 |
| Krezoxim-methyl | 12.5 |

### Example 13

### Formulation of the Invention (BF452)

| (Components) | [concentration (g/100 mL mL)] |
|---|---|
| Water | qsp |
| Polydimethylsiloxane | 0.2 |
| Tristyrylphenol phosphate with 16 | 3.0 |
| moles of neutralized ethene oxide | |
| Ethoxylated isotridecyl alcohol with | 1.0 |
| 6 moles of ethene oxide | |
| Benzisotiazolin | 0.25 |
| Monoethylene glycol | 9.0 |
| Xanthan gum | 0.35 |
| Carbendazim | 20 |
| Tebuconazole | 10 |
| Krezoxim-methyl | 12.5 |

### Example 14

### Formulation of the Invention (BF452)

| (Components) | [concentration (g/100 mL mL)] |
|---|---|
| Water | qsp |
| Silicon emulsion | 0.5 |
| Tristyrylphenol phosphate with 54 | 3.0 |
| moles of neutralized ethene oxide | |
| Ethoxylated lauryl alcohol with 7 | 1.0 |
| moles of ethene oxide | |
| Benzisotiazolin | 0.25 |
| Monoethylene glycol | 7.0 |
| Xanthan gum | 0.30 |
| Carbendazim | 20 |
| Tebuconazole | 10 |
| Krezoxim-methyl | 12.5 |

### Example 15

### Use of the Formulations of the Invention in Soybean, Coffee, Rice and Cotton Crops to Control and/or Treat Diseases/Pests

The development of new fungicides and the use of the synergistic action of molecules is an important component in the sustainability of production systems. Although Asian soybean rust has appeared in the last harvests, other diseases should be considered in the management of soybean crops. The fungicides used in controlling the disease, although they present a wide spectrum of control for most leaf spots, have low efficiency on target spot (Corynespora cassiicola) and anthracnose (Colletotrichum truncatum) and, due to the efficient control of rust, these diseases are gaining greater prominence in recent harvests. The use of benzimidazole fungicides, such as carbendazim or methyl thiophanate effectively complements the control of these diseases.

It was observed that the specific synergistic association of three fungicides is an important part in the sustainability of production systems, both in maintaining the efficacy of the complex of plant diseases and in managing microorganism resistance. This management of the selection of the pathogen is achieved by using three molecules with distinct modes of action: benzimidazole, acting on the integrity of tubulin; triazole, sterol synthesis inhibitor, ergosterol is the major lipid component of the plasma membrane of fungi, acting in inhibiting the formation of ergosterol; and strobilurin, which inhibits mitochondrial respiration by blocking the transfer of electrons in the complex cytochrome BC1 Qo site, interfering with the formation of ATP.

The isolated use of the tebuconazole, flutriafol, azoxystrobin, kresoxim-methyl and carbendazim fungicides is not effective in controlling rust (Phakopsora pachyrhizi Sydow) in soybean crops (see Tables 1 and 2 below), and the use of the association of tebuconazole with carbendazim or flutriafol with carbendazim does not provide adequate control under conditions of high disease severity.

The fungicides applied alone were not effective in controlling soybean rust, as can be observed by the high area under the disease-progress curve for azoxystrobin even at the dose of 60 g/ha ai or kresoxim-methyl at the dose of 125 g/ha ai. (See Table 1 below), carbendazim even at a dose of 250 g/ha ai, and tebuconazole at the dose of 100 g/ha ai. The low control efficacy resulted in lower crop productivity. The association tebuconazole+carbendazim (100+200 g/ha ai, respectively) was not effective in controlling soybean rust.

The association of azoxystrobin with the tebuconazole+carbendazim mixture (BF 488) provided a control efficacy gain and a residual control effect even under high pressure of Asian rust. This higher residual effect is observed by the maintenance of low values in the area under the disease-progress curve, which resulted in better crop yields (see Table 1 below). The addition of azoxystrobin from 6 g/ha ai in the mixture of tebuconazole+carbendazim (100+200 g/ha ai, respectively) has already reflected in rust efficacy gain, providing control similar to the efficacy standard of azoxystrobin+cyproconazole (60+24 g/ha ai, respectively), and this product is marketed by Syngenta as PrioriXtra®. The addition of azoxystrobin in doses of 18, 24 and 30 g/ha ai together with tebuconazole+carbendazim was effective for obtaining yields higher than the market standard containing 60 g/ha of azoxystrobin.

The association of kresoxim-methyl with the tebuconazole+carbendazim mixture (BF 452) provided a control efficacy gain and a residual control effect even under high pressure of Asian rust. This higher residual effect is observed by the maintenance of low values in the area under the disease-progress curve, which resulted in better crop yields (see Table 1 below). The addition of kresoxim-methyl from 75 g/ha ai in the mixture of tebuconazole+carbendazim (100+200 g/ha ai, respectively) has already reflected in rust efficacy gain, providing control similar to the efficacy standard of azoxystrobin+cyproconazole (60+24 g/ha ai, respectively), and this product is marketed by Syngenta as PrioriXtra®.

TABLE 1
Area under the disease-progress curve (AUDPC) and
yield in function of the interactions of fungicides for the control of Phakopsora
pachyrhizi Sydow. Rondonópolis—MT.

| | Treatment | Rate | AUPDC* | | | | Productivity | |
|---|---|---|---|---|---|---|---|---|
| | Common Name | g/ha a.i. | Lower Canopy | | Upper Canopy | | kg/ha | |
| 1 | azoxystrobrin + cyproconazol | 84 (60 + 24) | 337.0 | m | 48.0 | l | 2882.0 | c |
| 2 | kresoxym | 125 | 1146.0 | d | 978.0 | c | 1349.0 | j |
| 3 | azoxystrobrin | 60 | 1161.0 | c | 639.0 | d | 1547.0 | i |
| 4 | tebuconazol | 100 | 896.0 | e | 427.0 | e | 2152.0 | h |
| 5 | carbendazin | 250 | 261.0 | b | 1148.0 | b | 1324.0 | j |
| 6 | tebuconazol + kresoxym + carbendazin | 100 + 125 + 250 | 337.0 | b | 130.0 | h | 2942.0 | c |
| 7 | tebuconazol + kresoxym + carbendazin | 100 + 100 + 250 | 347.0 | lm | 102.0 | i | 2835.0 | cd |
| 8 | tebuconazol + kresoxym + carbendazin | 100 + 75 + 250 | 359.0 | l | 124.0 | h | 2911.0 | c |
| 9 | tebuconazol + kresoxym + carbendazin | 100 + 50 + 250 | 467.0 | i | 127.0 | h | 2420.0 | f |
| 10 | tebuconazol + kresoxym + carbendazin | 100 + 25 + 250 | 520.0 | h | 216.0 | g | 2116.0 | h |
| 11 | tebuconazol + carbendazin | 100 + 250 | 685.0 | f | 254.0 | f | 2188.0 | gh |
| 12 | tebuconazol + kresoxym + carbendazin | 100 + 75 + 200 | 383.0 | k | 121.0 | h | 2621.0 | e |
| 13 | tebuconazol + kresoxym + carbendazin | 100 + 50 + 200 | 431.0 | j | 121.0 | h | 2322.0 | fg |
| 14 | tebuconazol + kresoxym + carbendazin | 100 + 25 + 200 | 517.0 | h | 137.0 | h | 2263.0 | gh |
| 15 | tebuconazol + azoxystrobin + carbendazin | 100 + 30 + 250 | 303.0 | n | 33.0 | l | 3486.0 | a |
| 16 | tebuconazol + azoxystrobin + carbendazin | 100 + 24 + 250 | 259.0 | p | 35.0 | l | 3158.0 | b |
| 17 | tebuconazol + azoxystrobin + carbendazin | 100 + 18 + 250 | 258.0 | p | 38.0 | l | 3152.0 | b |
| 18 | tebuconazol + azoxystrobin + carbendazin | 100 + 12 + 250 | 269.0 | p | 43.0 | l | 2698.0 | de |
| 19 | tebuconazol + azoxystrobin + carbendazin | 100 + 6 + 250 | 340.0 | m | 88.0 | ij | 2683.0 | de |
| 20 | tebuconazol + carbendazin | 100 + 200 | 541.0 | g | 208.0 | g | 2176.0 | gh |
| 21 | tebuconazol + azoxystrobin + carbendazin | 100 + 18 + 200 | 240.0 | q | 69.0 | k | 3169.0 | b |
| 22 | tebuconazol + azoxystrobin + carbendazin | 100 + 12 + 200 | 241.0 | q | 67.0 | k | 2957.0 | c |
| 23 | tebuconazol + azoxystrobin + carbendazin | 100 + 6 + 200 | 285.0 | o | 77.0 | jk | 2689.0 | de |
| 24 | | | 316.0 | a | 491.0 | a | 54.0 | k |

| | | | |
|---|---|---|---|
| Tukey's HSD (P = .05) | 14.8 | 16.4 | 143.7 |
| CV | 1.94 | 4.15 | 4.12 |

*Area under the disease-progress curve

The fungicides applied alone were not effective in controlling soybean rust, as can be observed by the high area under the disease-progress curve for azoxystrobin even at the dose of 60 g/ha ai or kresoxim-methyl at the dose of 125 g/ha ai. (See Table 2 below), carbendazim even at a dose of 250 g/ha ai, and flutriafol at the dose of 62.5 g/ha ai. The low control efficacy resulted in lower crop productivity. The association flutriafol+carbendazim (62.5+200 g/ha ai, respectively) was not effective in controlling soybean rust.

The association of azoxystrobin with the flutriafol+carbendazim mixture (BF 489) provided a control efficacy gain and a residual control effect even under high pressure of Asian rust. This higher residual effect is observed by the maintenance of low values in the area under the disease-progress curve, which resulted in better crop yields (see Table 2 below). The addition of azoxystrobin from 6 g/ha ai in the mixture of flutriafol+carbendazim (62.5+200 g/ha ai, respectively) has already reflected in rust efficacy gain, providing control similar to the efficacy standard of azoxystrobin+cyproconazole (60+24 g/ha ai, respectively), and this product is marketed by Syngenta as PrioriXtra®. The addition of azoxystrobin in doses of 18, 24 and 30 g/ha ai together with flutriafol+carbendazim was effective for obtaining yields higher than the market standard containing 60 g/ha of azoxystrobin.

TABLE 2
Area under the disease-progress curve (AUDPC) and
yield in function of the interactions of fungicides for the control of Phakopsora
pachyrhizi Sydow. Rondonópolis—MT.

| | Treatment | Rate | AUPDC* | | | | Productivity | |
|---|---|---|---|---|---|---|---|---|
| | Common Name | g/ha a.i. | Lower Canopy | | Upper Canopy | | kg/ha | |
| 1 | azoxystrobrin + cyproconazol | 84 (60 + 24) | 618.9 | s | 103.5 | s | 2499.6 | a-d |
| 2 | kresoxym | 125 | 1415.8 | c | 1261.3 | c | 1479.5 | ijk |
| 3 | azoxystrobrin | 60 | 1385.0 | d | 1194.1 | d | 1707.8 | ghi |
| 4 | flutriafol | 62.5 | 1312.6 | e | 1097.2 | e | 1578.2 | hij |
| 5 | carbendazin | 250 | 1576.3 | b | 1317.0 | b | 1293.0 | jk |
| 6 | flutriafol + kresoxym + carbendazin | 62.5 + 125 + 250 | 846.9 | n | 408.1 | m | 2728.5 | a |
| 7 | flutriafol + kresoxym + carbendazin | 62.5 + 100 + 250 | 1001.9 | jk | 477.1 | k | 2524.4 | a-d |
| 8 | flutriafol + kresoxym + carbendazin | 62.5 + 75 + 250 | 948.0 | m | 537.4 | j | 2282.5 | de |
| 9 | flutriafol + kresoxym + carbendazin | 62.5 + 50 + 250 | 1010.0 | ij | 552.4 | i | 2281.5 | de |
| 10 | flutriafol + kresoxym + carbendazin | 62.5 + 25 + 250 | 986.1 | kl | 535.6 | j | 2260.8 | def |
| 11 | flutriafol + carbendazin | 62.5 + 250 | 1155.9 | g | 610.9 | g | 1152.8 | gh |
| 12 | flutriafol + kresoxym + carbendazin | 62.5 + 75 + 200 | 979.8 | l | 462.5 | l | 2306.4 | cde |
| 13 | flutriafol + kresoxym + carbendazin | 62.5 + 50 + 200 | 1019.9 | i | 567.4 | h | 2171.9 | ef |
| 14 | flutriafol + kresoxym + carbendazin | 62.5 + 25 + 200 | 1037.5 | h | 544.0 | ij | 1984.9 | fg |
| 15 | flutriafol + azoxystrobin + carbendazin | 62.5 + 30 + 250 | 711.6 | r | 236.3 | r | 2614.5 | ab |
| 16 | flutriafol + azoxystrobin + carbendazin | 62.5 + 24 + 250 | 767.4 | q | 302.4 | p | 2621.5 | abc |
| 17 | flutriafol + azoxystrobin + carbendazin | 62.5 + 18 + 250 | 838.6 | n | 341.6 | n | 2596.7 | abc |
| 18 | flutriafol + azoxystrobin + carbendazin | 62.5 + 12 + 250 | 854.7 | n | 457.0 | l | 2595.2 | abc |
| 19 | flutriafol + azoxystrobin + carbendazin | 62.5 + 6 + 250 I | 988.8 | kl | 574.0 | h | 2270.0 | def |
| 20 | flutriafol + carbendazin | 62.5 +30200 | 1241.8 | f | 988.9 | f | 1439.8 | ijk |
| 21 | flutriafol + azoxystrobin + carbendazin | 62.5 + 18 + 200 | 816.1 | o | 317.6 | o | 2616.3 | ab |
| 22 | flutriafol + azoxystrobin + carbendazin | 62.5 + 12 + 200 | 783.9 | p | 284.6 | q | 2600.3 | ab |
| 23 | flutriafol + azoxystrobin + carbendazin | 62.5 + 6 + 200 | 804.6 | o | 294.6 | p | 2342.1 | b-e |
| 24 | Check | | 1726.3 | a | 1492.5 | a | 1236.4 | k |

| | | | |
|---|---|---|---|
| Tukey's HSD (P = .05) | 16.544 | 9.706 | 290.574 |
| CV | 0.61 | 0.6 | 5.15 |

*Area under the disease-progress curve

The association of kresoxim-methyl with the flutriafol+carbendazim mixture (BF 465) provided a control efficacy gain and a residual control effect even under high pressure of Asian rust. This higher residual effect is observed by the maintenance of low values in the area under the disease-progress curve, which resulted in better crop yields (see Table 2 above). The addition of kresoxim-methyl from 75 g/ha ai in the mixture of flutriafol+carbendazim (62.5+200 g/ha ai, respectively) has already reflected in rust efficacy gain, providing control similar to the efficacy standard of azoxystrobin+cyproconazole (60+24 g/ha ai, respectively), and this product is marketed by Syngenta as PrioriXtra®.

A study was prepared to analyze the interaction effect using the multiplicative model of distribution proposed by Colby (1967), using Equation 1 below to calculate the expected response:

E=100−[((100−x)*(100−y))/100] Equation 1:

wherein E is the expected reduction in disease development (such as the reduction in the percentage of expected control or the reduction in the area under the disease-progress curve), and x and y represent the reduction in disease development achieved by treatment with fungicide x and y, respectively.

The possible interaction responses are:
a) antagonism, which is characterized by joint action of two fungicides showing the response of a test organism in their combination that is lower than the expected response, obtained by appropriate reference models, as proposed by Colby (1967);
b) synergism, which is the cooperative action of two fungicides showing a response in the test organism on the joint application that is higher than the expected response obtained by appropriate reference models, and
c) additive, which occurs when two fungicides react by presenting a response in the test organism on the joint application that is equal to the expected response obtained by appropriate reference models.

To use the model proposed by Colby, the association tebuconazole+carbendazim (100+200, respectively) was established for a comparative test with azoxystrobin or kresoxim-methyl and a response of the type of interaction (see Table 3 below).

The association tebuconazole+carbendazim+azoxystrobin (100+200+30 g/ha ai, respectively) provided a synergistic effect in their interaction in the control of soybean rust, as shown in Table 3 below. This synergistic interaction was effective in controlling the disease, both in the bottom leaves and in the top leaves of the soybean plant. The synergism in disease control in the bottom leaves reflects high control efficacy, since the products used reach the leaves in smaller amounts at this position, and the disease has a better condition for its development.

The association tebuconazole+carbendazim+kresoxim-methyl (100+200+125 g/ha ai, respectively) provided a synergistic effect in its interaction in the control of soybean rust, as shown in Table 3 below. This synergistic interaction was effective in controlling the disease, both in the bottom leaves and in the top leaves of the soybean plant. The synergism in disease control in the bottom leaves reflects high control efficacy, since the products used reach the leaves in smaller amounts at this position and the disease has a better condition for its development.

TABLE 3
Effective control of Phakopsora pachyrhizi obtained by
area under the disease-progress curve (AUDPC) in the lower canopy and
upper canopy due to interactions of fungicides and expected control (Colby).
Rondonópolis—MT.

| | | | Control (%) | |
|---|---|---|---|---|
| | Treatment | Rate | Lower | |
| | Common name | g/ha ai | canopy | Upper canopy |
| 1 | Kresoxim-methyl | 125 | 13 | 34 |
| 2 | Azoxystrobin | 30 | 12 | 57 |
| 3 | Tebuconazole | 100 | 32 | 71 |
| 4 | Tebuconazole + | 100 + 200 + 125 | 74 (64.3)*+ | 94 (90.8)+ |
| | Carbendazim + | | | |
| | Kresoxim | | | |
| 5 | Tebuconazole + | 100 + 200 + 30 | 77 (63.9)+ | 98 (94.0)+ |
| | Carbendazim + | | | |
| | Azoxystrobin | | | |
| 6 | Tebuconazole + | 100 + 200 | 59 | 86 |
| | Carbendazim | | | |
| 7 | Control | | 0 | 0 |

| | | |
|---|---|---|
| LSD (P = .05) | 1.4 | 1.4 |
| CV | 2.38 | 1.48 |

*Figures in brackets are the expected values calculated by the Colby equation (1967). The negative sign after the expected value indicates an antagonistic effect on the interaction; the positive sign indicates a synergism effect, and no sign indicates an additive interaction.

Regarding the study of the interaction effect for the association of flutriafol+carbendazim+azoxystrobin and flutriafol+carbendazim+kresoxim-methyl, the model proposed by Colby was used. To use the model proposed by Colby, the association flutriafol+carbendazim (62.5+200, respectively) was established for a comparative test with azoxystrobin or kresoxim-methyl and a response of the type of interaction (see Table 4 below).

The association flutriafol+carbendazim+azoxystrobin (62.5+200+30 g/ha ai, respectively) provided a synergistic effect in its interaction in the control of soybean rust, as shown in Table 4 below. This synergistic interaction was effective in controlling the disease, both in the bottom leaves and in the top leaves of the soybean plant. The synergism in disease control in the bottom leaves reflects high control efficacy, since the products used reach the leaves in smaller amounts at this position and the disease has a better condition for its development.

The association flutriafol+carbendazim+kresoxim-methyl (62.5+200+125 g/ha ai, respectively) provided a synergistic effect in its interaction in the control of soybean rust, as shown in Table 4 below. This synergistic interaction was effective in controlling the disease, both in the bottom leaves and in the top leaves of the soybean plant. The synergism in disease control in the bottom leaves reflects high control efficacy, since the products used reach the leaves in smaller amounts at this position and the disease has a better condition for its development.

TABLE 4
Effective control of Phakopsora pachyrhizi obtained by
area under the disease-progress curve (AUDPC) in the lower
canopy and upper canopy due to interactions of fungicides
and expected control (Colby). Rondonópolis—MT.

| | Treatment | Rate | Control (%) | |
|---|---|---|---|---|
| | Common name | g/há ai | Lower canopy | Upper canopy |
| 1 | Kresoxim-methyl | 125 | 18.0 | 15.5 |
| 2 | Azoxystrobin | 30 | 19.8 | 20.0 |
| 3 | Flutriafol | 62.5 | 24.0 | 26.5 |
| 4 | Flutriafol + | 62.5 + 200 + 125 | 50.9 (45,1)*+ | 72.7 (65.4)+ |
| | Carbendazim + | | | |
| | Kresoxim | | | |
| 5 | Flutriafol + | 62.5 + 200 + 30 | 58.8 (46.3)+ | 84.2 (67.3)+ |
| | Carbendazim + | | | |
| | Azoxystrobin | | | |
| 6 | Flutriafol + | 62.5 + 200 | 33.0 | 59.1 |
| | Carbendazim | | | |
| 7 | Control | | 0.0 | 0.0 |

| | | |
|---|---|---|
| LSD (P = .05) | 0.85 | 0.83 |
| CV | 1.97 | 1.41 |

*Figures in brackets are the expected values calculated by the Colby equation (1967). The negative sign after the expected value indicates an antagonistic effect on the interaction; the positive sign indicates a synergism effect, and no sign indicates an additive interaction.

The association of azoxystrobin with tebuconazole and carbendazim or the association of kresoxim-methyl with tebuconazole and carbendazim provide highly effective control of rust (see Table 1 above) and this interaction has a synergistic effect (see Table 3 above). In addition to these benefits, the association of the three fungicides—tebuconazole, carbendazim and azoxystrobin or tebuconazole, carbendazim and kresoxim-methyl provides greater safety regarding protection against the emergence of fungi resistant to fungicides and improved control spectrum. The increase in the control spectrum can be seen in Table 5 below by the highly effective control of target spot (Corynespora cassiicola) and anthracnose (Colletotrichum truncatum).

TABLE 5
Average results of target spot severity (Corynespora
cassiicola) and anthracnose (Colletotrichum truncatum) 14 days after the
third application in view of fungicide interactions. Rondonópolis—MT.

| | Treatment | Rate | Severity (%) | | | |
|---|---|---|---|---|---|---|
| | Common Name | g/ha a.i. | C. cassiicola | | C. truncatum | |
| 1 | azoxystrobrin + cyproconazol | 84 (60 + 24) | 23.3 | b | 17.0 | bc |
| 2 | kresoxym | 125 | 22.3 | b | 19.5 | b |
| 3 | azoxystrobrin | 60 | 23.0 | b | 13.8 | c |
| 4 | Tebuconazol | 100 | 23.5 | b | 30.0 | a |
| 5 | flutriafol | 62.5 | 22.5 | b | 31.3 | a |
| 6 | tebuconazol + kresoxym + carbendazin | 100 + 125 + 200 | 3.8 | c | 2.3 | d |
| 7 | flutriafol + kresoxym + carbendazin | 62.5 + 125 + 200 | 4.5 | c | 3.3 | d |
| 8 | tebuconazol + kresoxym + carbendazin | 100 + 25 + 200 | 4.5 | c | 2.5 | d |
| 9 | flutriafol + kresoxym + carbendazin | 62.5 + 25 + 200 | 3.5 | c | 3.3 | d |
| 10 | tebuconazol + azoxystrobin + carbendazin | 100 + 30 + 200 | 4.5 | c | 2.3 | d |
| 11 | flutriafol + azoxystrobin + carbendazin | 62.5 + 30 + 200 | 3.8 | c | 3.5 | d |
| 12 | tebuconazol + azoxystrobin + carbendazin | 100 + 6 + 200 | 3.5 | c | 3.5 | d |
| 13 | flutriafol + azoxystrobin + carbendazin | 62.5 + 6 + 200 | 3.5 | c | 2.5 | d |
| 14 | Check | | 36.0 | a | 32.3 | a |

| | | |
|---|---|---|
| Tukey's HSD (P = .05) | 4.459 | 4.617 |
| CV | 13.58 | 15.35 |

* Target spot (Corynespora cassiicola)
** anthracnose (Colletotrichum truncatum)

The association of azoxystrobin with flutriafol and carbendazim or the association of kresoxim-methyl with flutriafol and carbendazim provide highly effective control of rust (see Table 2 above) and this interaction has a synergistic effect (see Table 4 above). In addition to these benefits, the association of the three fungicides—flutriafol, carbendazim and azoxystrobin or flutriafol, carbendazim and kresoxim-methyl provides greater safety regarding protection against the emergence of fungi resistant to fungicides and improved control spectrum. The increase in the control spectrum can be seen in Table 5 above by the highly effective control of target spot (Corynespora cassiicola) and anthracnose (Colletotrichum truncatum).

The soybean target spot is caused by fungus Corynespora cassiicola (Berk. & M. A. Curtis) C. T. Wei. This pathogen was first identified in the U.S. in 1945 under the name Helminthosporium vignae. In Brazil, the first records were in 1974 in the states of Mato Grosso and Paraná in 1976 (Almeida et al., 1976). Severe, but sporadic, outbreaks have been observed in the colder regions of the South and in upland regions of the cerrado (Tecnologias . . . , 2008). It has had significant expression in the last crops mainly in the states of Mato Grosso and Tocantins, where it occurs with greater severity; however, it also occurs in soybean areas around the cerrado region.

The fungus is found in virtually all regions of soybean cultivation in Brazil, and it is considered to be native and infect a large number of plant species. It can survive in crop residues and infected seeds, which is one way of spreading. Conditions of high humidity and warm temperatures are conducive to leaf infections. The most common symptoms are leaf spots with yellow halo and dark spots in the center, causing severe defoliation. Spots also occur on the stem and pod. The fungus can also infect roots, causing root rot and intensive sporulation (Henning et al., 2005).

Another disease of growing importance in soybean is anthracnose, this is caused by Colletotrichum dematium (Pers. Ex Fr.) Grove var. truncata (Schw) Arx (sin. C. truncatum (Schw.) Andrus & Moore. Anthracnose is a major disease in the crop at all stages of development from seedling stage to the early stage of pod filling, which makes it an important problem in the cerrado region. In rainy years, it can cause total loss of production, with significant reduction in the number of pods (Yorinori, 1997).

Higher intensities of the occurrence of anthracnose in the cerrado regions have been attributed to high rainfall and high temperatures. The use of infected seeds also contributes to a higher incidence of the disease. A considerable increase has been observed in the occurrence of Colletotrichum truncatum in soybean seeds evaluated by the blotter test. Seeds from crops that have delayed harvest due to rainfall showed infection percentages above 50% (Almeida et al., 1997).

The occurrence of soybean rust from the 2001/2002 harvest on led producers and technicians to divert their attention from other important diseases, such as anthracnose and target spot. Several strategies are recommended for disease control, such as: the use of resistant cultivars, seed treatment, crop rotation with corn and grass species and fungicide spraying (Almeida et al., 1997, Henning et al. 2005; Yorinori et al., 2010). However, the fungicides commonly used in the management of soybean rust are less effective in controlling these diseases.

The isolated use of the tebuconazole, flutriafol, azoxystrobin and kresoxim-methyl fungicides is not effective in controlling target spot (C. cassiicola) and anthracnose (C. truncatum) in soybean crops (see Table 5 above), and the use of a standard fungicide to control soybean rust, the association of azoxystrobin and cyproconazole (PrioriXtra®) does not provide adequate control under conditions of high disease severity.

The fungicides applied alone were not effective in controlling target spot and anthracnose in soybean crops, as can be observed by the high severity of the disease for azoxystrobin even at the dose of 60 g/ha ai or kresoxim-methyl at the dose of 125 g/ha ai. (See Table 5 above).

The association of azoxystrobin with the tebuconazole+carbendazim mixture provided a control efficacy gain and a residual control effect even under high pressure of target spot and anthracnose. This higher control effect is observed by the lower severity of the diseases (see Table 5 above). The addition of azoxystrobin from 6 g/ha ai in the mixture of tebuconazole+carbendazim (100+200 g/ha ai, respectively) has already reflected in the efficacy gain of target spot and anthracnose, providing more control than the efficacy standard of azoxystrobin+cyproconazole (60+24 g/ha ai, respectively) (PrioriXtra®).

The association of kresoxim-methyl with the tebuconazole+carbendazim mixture provided a control efficacy gain and a residual control effect even under high pressure of target spot and anthracnose. This higher residual effect is observed by the maintenance of low severity values (see Table 5 above). The addition of kresoxim-methyl from 25 g/ha ai in the mixture of tebuconazole+carbendazim (100+200 g/ha ai, respectively) has already reflected in the efficacy gain of target spot and anthracnose, providing more control than azoxystrobin+cyproconazole (60+24 g/ha ai, respectively) (PrioriXtra®).

The association of azoxystrobin with the flutriafol+carbendazim mixture provided a control efficacy gain and a residual control effect even under high pressure of target spot and anthracnose. This higher control effect is observed by the lower severity of the diseases (see Table 5 above). The addition of azoxystrobin from 6 g/ha ai in the mixture of flutriafol+carbendazim (62.5+200 g/ha ai, respectively) has already reflected in the efficacy gain of target spot and anthracnose, providing more control than the efficacy standard of azoxystrobin+cyproconazole (60+24 g/ha ai, respectively) (PrioriXtra®).

The association of kresoxim-methyl with the flutriafol+carbendazim mixture provided a control efficacy gain and a residual control effect even under high pressure of target spot and anthracnose. This higher residual effect is observed by the maintenance of low severity values (see Table 5 above). The addition of kresoxim-methyl from 25 g/ha ai in the mixture of flutriafol+carbendazim (62.5+200 g/ha ai, respectively) has already reflected in the efficacy gain of target spot and anthracnose, providing more control than azoxystrobin+cyproconazole (60+24 g/ha ai, respectively) (PrioriXtra®).

In intensive production systems there is greater disease pressure and the emergence of new diseases that were not important, causing production losses. This has been observed in recent years in soybean crops primarily with the target spot and anthracnose diseases. Tebuconazole alone is not effective in controlling these diseases even using twice the recommended commercial dose, similar to azoxystrobin in the soybean crop. The association of azoxystrobin with the tebuconazole+carbendazim mixture provided adequate levels of control for target spot and anthracnose.

The association of azoxystrobin with the tebuconazole+carbendazim mixture provided high control efficacy of rust (see Table 6 below). The addition of azoxystrobin provides a synergistic effect in the control of Asian rust. The association of the three fungicides tebuconazole, carbendazim and azoxystrobin provides effective control of target spot (Corynespora cassiicola) and anthracnose (Colletotrichum truncatum) (see Table 5 above), and contains fungicides with three modes of action—carbendazim (benzimidazole)—acting on the integrity of tubulin; tebuconazole (triazole)—sterol synthesis inhibitors; azoxystrobin (strobilurin)—inhibits mitochondrial respiration.

TABLE 6
Area under the disease-progress curve (AUDPC) and
yield in function of the interactions of fungicides for the control of Phakopsora
pachyrhizi Sydow. Rondonópolis—MT.

| | Treatment | Rate | AUPDC* | | | | Productivity | |
|---|---|---|---|---|---|---|---|---|
| | Common name | g/ha a.i. | Lower Canopy | | Upper Canopy | | kg/ha | |
| 1 | azoxystrobrin + cyproconazol | 84 (60 + 24) | 392.6 | ef | 56.6 | ghi | 2879.8 | bc |
| 2 | kresoxym | 125 | 1245.9 | b | 1074.1 | c | 1848.5 | fg |
| 3 | azoxystrobrin | 60 | 189.8 | b | 736.1 | d | 1546.5 | f |
| 4 | Tebuconazol | 100 | 747.4 | c | 227.5 | e | 2570.8 | e |
| 5 | carbendazin | 250 | 361.8 | a | 247.5 | b | 1323.7 | g |
| 6 | tebuconazol + kresoxym + carbendazin | 100 + 125 + 200 | 391.9 | ef | 57.5 | ghi | 2889.8 | bc |
| 7 | tebuconazol + kresoxym + carbendazin | 100 + 100 + 200 | 414.9 | e | 64.3 | ghi | 2806.3 | cd |
| 8 | tebuconazol + kresoxym + carbendazin | 100 + 75 + 200 | 438.6 | e | 81.8 | fg | 2865.4 | bc |
| 9 | tebuconazol + kresoxym + carbendazin | 100 + 50+ 200 | 498.7 | d | 107.4 | f | 2757.3 | cde |
| 10 | tebuconazol + kresoxym + carbendazin | 100 + 25 + 200 | 512.6 | d | 195.7 | e | 2719.6 | cde |
| 11 | tebuconazol + azoxystrobin + carbendazin | 100 + 30 + 200 | 271.1 | i | 27.8 | i | 3292.5 | a |
| 12 | tebuconazol + azoxystrobin + carbendazin | 100 + 24 + 200 | 295.4 | hi | 36.3 | hi | 3038.1 | b |
| 13 | tebuconazol + azoxystrobin + carbendazin | 100 + 30 + 200 | 331.3 | gh | 39.3 | hi | 3038.6 | b |
| 14 | tebuconazol + azoxystrobin + carbendazin | 100 + 12 + 200 | 354.8 | fg | 51.8 | ghi | 2881.9 | bc |
| 15 | tebuconazol + azoxystrobin + carbendazin | 100 + 6 + 200 | 406.6 | ef | 66.1 | gh | 2820.5 | c |
| 16 | tebuconazol + carbendazin | 100 + 200 | 745.2 | c | 220.3 | e | 2608.8 | de |
| 17 | Check | | 1416.8 | a | 1591.3 | a | 1154.0 | g |

| | | | |
|---|---|---|---|
| Tukey's HSD (P = .05) | 58.406 | 37.538 | 205.97 |
| CV | 3.48 | 4.19 | 3.18 |

*area under the disease-progress curve

The association of kresoxim-methyl with the tebuconazole+carbendazim mixture provided high control efficacy of rust (see Table 6 above). The addition of kresoxim-methyl provides a synergistic effect in the control of Asian rust. The association of the three fungicides tebuconazole, carbendazim and kresoxim-methyl provides effective control of target spot (Corynespora cassiicola) and anthracnose (Colletotrichum truncatum) (see Table 5 above), and contains fungicides with three modes of action—carbendazim (benzimidazole)—acting on the integrity of tubulin; tebuconazole (triazole)—sterol synthesis inhibitors; azoxystrobin (strobilurin)-inhibits mitochondrial respiration.

Similarly, the association of azoxystrobin with flutriafol and carbendazim or the association of kresoxim-methyl with flutriafol and carbendazim provide highly effective control of rust (see Table 2 above). The addition of azoxystrobin and kresoxim-methyl to flutriafol and carbendazim provides a synergistic effect in the control of Asian rust. The association of the three fungicides flutriafol, carbendazim and azoxystrobin or flutriafol, carbendazim and kresoxim-methyl provides effective control of target spot (Corynespora cassiicola) and anthracnose (Colletotrichum truncatum) (see Table 5 above), and contains fungicides with three modes of action—carbendazim (benzimidazole)—acting on the integrity of tubulin; flutriafol (triazole)—sterol synthesis inhibitors; azoxystrobin and kresoxim-methyl (strobilurin)—inhibits mitochondrial respiration.

For a better observation of the innovation introduced by the present invention, product BF 488 (tebuconazole 100+carbendazim 200+azoxistrobin 30) is compared with market standard commercial products PrioriXtra® (Syngenta) and Opera® (Basf) (see Tables 7 and 9 below). Product BF 488 is effective in controlling soybean rust, being better than industry standards. BF 488 provided better control of rust on the botton, median and top leaves of the soybean plant, reflected by high efficacy and better residual control. The better control of the disease provided by the synergistic effect of the balanced association of molecules of BF 488 (tebuconazole 100+carbendazim 200+azoxystrobin 30) can be seen in the improved productivity and in the greater mass of 1,000 grains of soybean, even when compared to PrioriXtra® (azoxystrobin+cyproconazole, 60+24 g/ha ai, respectively).

TABLE 7
Area under the disease-progress curve (AUDPC) and yield in function of the interactions of fungicides
for the control of Phakopsora pachyrhizi Sydow, Luis Eduardo Magalhães-BA.

| Treatment | | | AUDPC | | | | | | | | Mass (g) | | Productivity | |
|---|---|---|---|---|---|---|---|---|---|---|---|---|---|---|
| No. | Name | Rate g ha⁻¹a.i. | LEALOW | | LEAMID | | LEAUPP | | PLATOT | | 1000 grain | | kg ha⁻¹ | |
| 1 | UNTREATED | | [symbol] | a | [symbol] | a | [symbol] | a | [symbol] | a | [symbol] | b | [symbol] | d |
| 2 | ProductX | | 1029.3 | b | 843.4 | b | 503.1 | b | 791.9 | b | 133.8 | a | 3161.1 | c |
| 3 | ProductY | | 938.1 | bc | 843.4 | b | 449.4 | bcd | 743.6 | b | 132.5 | a | 3693.5 | b |
| 4 | BF 488-01 | 100 + 200 + 30 | 830.0 | d | 702.1 | cd | 411.3 | cd | 647.8 | cd | 140.0 | a | 3975.0 | ab |
| 5 | BF 488-01 | 120 + 240 + 36 | 778.1 | d | 618.6 | d | 367.2 | d | 588.0 | d | 138.8 | a | 4150.0 | a |
| 6 | PRIORI XTRA | 60 + 24 | 923.5 | c | 756.3 | bc | 474.2 | bc | 718.6 | bc | 130.0 | a | 3893.6 | ab |
| 7 | OPERA | 66.5 + 25 | 982.3 | bc | 768.6 | bc | 474.6 | bc | 741.8 | b | 133.8 | a | 3771.3 | b |

| | | | | | | |
|---|---|---|---|---|---|---|
| LSD (P = .05) | 88.3 | 124.66 | 79.21 | 81.59 | 12.184 | 262.439 |
| CV | 5.7 | 9.73 | 9.42 | 6.67 | 6.22 | 4.84 |

* Addition of Assist (emusifiable mineral oil) 0.5% v/v in all treatments. [symbol]
indicates data missing or illegible when filed

For a better observation of the innovation introduced by the present invention, product BF 452 (tebuconazole 100+carbendazim 200+kresoxim-methyl 125) is compared with market standard commercial products PrioriXtra® (Syngenta) and Opera® (Basf) (see Tables 8 and 9 below). The BF 452 is effective in controlling soybean rust, being better than industry standards. Product BF 452 provided better control of rust on the botton, median and top leaves of the soybean plant, reflected by high efficacy and better residual control. The better control of the disease provided by the synergistic effect of the balanced association of molecules of BF 452 (tebuconazole 100+carbendazim 200+kresoxim-methyl 125) can be seen in the improved productivity of soybean, even when compared to PrioriXtra® (azoxystrobin+cyproconazole, 60+24 g/ha ai, respectively).

For a better observation of the innovation introduced by the present invention, product BF 465 (flutriafol 62.5+carbendazim 200+kresoxim-methyl 125) is compared with market standard commercial products PrioriXtra® (Syngenta) and Opera® (Basf) (see Tables 8 and 9 below). Product BF 465 is effective in controlling soybean rust, being similar to industry standards. The BF 465 provided excellent control of rust on the botton, median and top leaves of the soybean plant, reflected by high efficacy and better residual control. The better control of the disease provided by the synergistic effect of the balanced association of molecules of BF 465 (flutriafol 62.5+carbendazim 200+kresoxim-methyl 125) can be seen in the improved productivity of soybean, even when compared to PrioriXtra® (azoxystrobin+cyproconazole, 60+24 g/ha ai, respectively).

TABLE 8
Area under the disease-progress curve (AUDPC) and yield in function of
the interactions of fungicides for the control of Phakopsora pachyrhizi Sydow, Rio Verde-GO.

| Treatment | | | AUDPC | | | | | | | | Productivity | |
|---|---|---|---|---|---|---|---|---|---|---|---|---|
| % | Name | Rate g ha⁻¹ a.i. | LEALOW | | LEAMID | | LEAUPP | | PLATOT | | kg ha⁻¹ | |
| 1 | CHECK | | 1324.0 | a | 1130.9 | a | 545.0 | a | 1000.0 | a | 2014.1 | b |
| 2 | BF 465-03 | 62.5 + 200 + 125 | 609.2 | c | 402.0 | c | 20.0 | c | 343.7 | c | 2750.5 | a |
| 3 | ProductX | | 584.5 | cd | 378.6 | cd | 21.1 | c | 328.1 | cd | 2610.0 | a |
| 4 | ProductY | | 580.1 | cd | 341.2 | cde | 16.7 | c | 312.7 | cde | 2758.3 | a |
| 5 | BF 452-03 | 100 + 200 + 125 | 543.0 | cd | 321.9 | de | 17.5 | c | 294.1 | cde | 2731.2 | a |
| 6 | ProductT | | 519.0 | cd | 333.7 | cde | 14.5 | c | 289.1 | de | 2730.3 | a |
| 7 | ProductZ | | 504.5 | d | 283.9 | e | 11.1 | c | 266.5 | e | 2804.4 | a |
| 8 | PRIORI XTRA | 24 + 60 | 616.9 | c | 318.7 | de | 22.3 | c | 319.3 | cd | 2731.0 | a |
| 9 | OPERA | 25 + 66.5 | 593.2 | cd | 348.1 | cde | 33.5 | c | 324.9 | cd | 2606.3 | a |
| 10 | FOLICUR | 100 | 1014.4 | b | 584.9 | b | 89.5 | b | 562.9 | b | 2570.5 | a |

| | | | | | |
|---|---|---|---|---|---|
| CV (%) | 9.2 | 9.6 | 21.4 | 8.0 | 6.16 |

* Addition of Assist (emusifiable mineral oil) 0.5% v/v in all treatments.

TABLE 9
Area under the disease-progress curve (AUDPC) and yield in function of
the interactions of fungicides for the control of Phakopsora pachyrhizi Sydow, Santa Helena de Goiás-GO.

| Treatment | | | AUDPC | | | | | | | | Productivity | |
|---|---|---|---|---|---|---|---|---|---|---|---|---|
| % | Name | Rate g ha⁻¹ a.i. | LEALOW | | LEAMID | | LEAUPP | | PLATOT | | kg ha⁻¹ | |
| 1 | CHECK | | 3105.8 | a | 2686.2 | a | 1851.2 | a | 2547.7 | a | 617.8 | d |
| 2 | BF 465-03 | 62.5 + 200 + 125 | 2446.4 | d | 1289.4 | c | 949.5 | c | 1561.8 | c | 1831.7 | bc |
| 3 | ProductX | | 2465.1 | d | 1289.6 | c | 936.5 | c | 1563.7 | c | 1720.0 | bc |
| 4 | BF 489 | 62.5 + 200 + 30 | 2364.0 | e | 1189.4 | d | 193.5 | e | 1248.9 | g | 2452.4 | a |
| 5 | BF 452-03 | 100 + 200 + 125 | 2285.8 | f | 1189.6 | d | 925.5 | c | 1466.9 | d | 1922.8 | ab |
| 6 | ProductY | | 2286.0 | f | 1189.4 | d | 928.5 | c | 1468.0 | d | 1992.1 | ab |
| 7 | BF 488 | 100 + 200 + 30 | 2203.7 | g | 1188.5 | d | 433.5 | d | 1275.2 | g | 2195.8 | ab |
| 8 | PRIORI XTRA | 84 | 2446.0 | d | 1289.3 | c | 377.5 | d | 1370.9 | f | 2131.0 | ab |
| 9 | OPERA | 91.5 | 2500.6 | c | 1364.5 | c | 379.7 | d | 1414.9 | e | 2176.9 | ab |
| 10 | FOLICUR | 100 | 2761.3 | b | 2017.6 | b | 1284.9 | b | 2021.3 | b | 1334.4 | c |

| | | | | | |
|---|---|---|---|---|---|
| CV (%) | 0.36 | 2.41 | 3.83 | 1.12 | 12.54 |

* Addition of Assist (emusifiable mineral oil) 0.5% v/v in all treatments.

For a better observation of the innovation introduced by the present invention, product BF 489 (flutriafol 62.5+carbendazim 200+azoxystrobin 30) is compared with market standard commercial products PrioriXtra® (Syngenta) and Opera® (Basf) (see Table 9 above). Product BF 489 is effective in controlling soybean rust, even under high disease pressure, being better than industry standards. BF 489 provided better control of rust on the botton, median and top leaves of the soybean plant, reflected by high efficacy and better residual control. The better control of the disease provided by the synergistic effect of the balanced association of molecules of BF 489 (flutriafol 62.5+carbendazim 200+azoxystrobin 30) can be seen in the improved productivity of soybean, even when compared to PrioriXtra® (azoxystrobin+cyproconazole, 60+24 g/ha ai, respectively) and to Opera®.

The synergistic association of azoxystrobin with tebuconazole and carbendazim provides highly effective control of rust (Tables 1, 6, 7, 9, 10, 12 and 13) and this interaction has a synergistic effect (Table 3). In addition to these benefits, the association of three fungicides tebuconazole, carbendazim and azoxystrobin provides greater safety regarding protection against the emergence of fungi resistant to fungicides and improved control spectrum.

The synergistic association of azoxystrobin with flutriafol and carbendazim provides highly effective control of rust (Tables 2, 9, 10, 12 and 13) and this interaction has a synergistic effect (Table 4). In addition to these benefits, the association of three fungicides flutriafol, carbendazim and azoxystrobin provides greater safety regarding protection against the emergence of fungi resistant to fungicides and improved control spectrum.

The synergistic association of kresoxim-methyl with tebuconazole and carbendazim provides highly effective control of rust (Tables 1, 6, 8, 9, 11 and 12) and this interaction has a synergistic effect (Table 3). In addition to these benefits, the association of three fungicides tebuconazole, carbendazim and kresoxim-methyl provides greater safety regarding protection against the emergence of fungi resistant to fungicides and improved control spectrum.

The synergistic association of kresoxim-methyl with flutriafol and carbendazim provides highly effective control of rust (Tables 2, 8, 9, 11 and 12) and this interaction has a synergistic effect (Table 4). In addition to these benefits, the association of three fungicides flutriafol, carbendazim and kresoxim-methyl provides greater safety regarding protection against the emergence of fungi resistant to fungicides and improved control spectrum.

This synergistic association of three molecules with a balanced ratio provides highly effective control of major diseases of difficult management in soybean crops, such as the target spot (Corynespora cassiicola) and anthracnose (Colletotrichum truncatum) (Table 5 above). It also provides highly effective control of septoria (Septoria glycines) (Table 14 below), gray leaf spot (Cercospora kikuchii) (Table 15 below) and white mold (Sclerotinia sclerotiorum) (Table 16 below) in soybean crops.

This synergistic interaction provides the increment of the disease control spectrum in crops with the application of products BF 488 (tebuconazole+carbendazim+azoxystrobin), BF 489 (flutriafol+carbendazim+azoxystrobin), BF 452 (tebuconazole+carbendazim+kresoxim-methyl) and BF 465 (flutriafol+carbendazim+kresoxim-methyl), with no need to mix the products in the spray tank, and to have the immediate re-entry into the area with another product. This fact is a function of the synergistic association of three modes of action of fungicides, triazoles—which are highly effective in controlling Ascomycetes and Basidiomycetes, and have some action in controlling Deuteromycete; benzimidazoles—which are highly effective in controlling Deuteromycetes and have some action in controlling Ascomycetes and Basidiomycetes; and strobilurins—which are highly effective in controlling Deuteromycetes and have some action in controlling Oomycetes and Basidiomycetes and little activity in Ascomycetes.

Synergistic interactions BF 488 (tebuconazole+carbendazim+azoxystrobin), BF 489 (flutriafol+carbendazim+azoxystrobin), BF 452 (tebuconazole+carbendazim+kresoxim-methyl) and BF 465 (flutriafol+carbendazim+kresoxim-methyl) provide highly effective control of the disease complex in corn crops, such as: Northern corn leaf blight (Exerohilum turcicum) (Table 22 below); White leaf spot or phaeosphaeria (Phaeosphaeria maydis) (Table 24 below); Diplodia spot (Diplodia macrospora); Cercosporiosis (Cercospora zea-maydis) (Table 21 below); Anthracnose (Colletotrichum graminicola) (Tables 17, 19 and 25 below); Southern rust (Puccinia polysora) (Table 20 below); Tropical rust (Physopella zeae) (Table 18 below); Common rust (Puccinia sorghi) (Tables 17 and 23 below).

Synergistic interactions BF 488 (tebuconazole+carbendazim+azoxystrobin), BF 489 (flutriafol+carbendazim+azoxystrobin), BF 452 (tebuconazole+carbendazim+kresoxim-methyl) and BF 465 (flutriafol+carbendazim+kresoxim-methyl) provide highly effective control of the disease complex in rice crops, such as: Blast (Pyricularia grisea) and Brown spot (Bipolaris oryzae) (Tables 26, 27 and 28 below).

Synergistic interactions BF 488 (tebuconazole+carbendazim+azoxystrobin), BF 489 (flutriafol+carbendazim+azoxystrobin), BF 452 (tebuconazole+carbendazim+kresoxim-methyl) and BF 465 (flutriafol+carbendazim+kresoxim-methyl) provide highly effective control of the major foliar diseases of cotton crops in Brazil, such as: Boll rot (Colletotrichum gossypii var. cephalosporioides) (Tables 32 and 33 below); Ramularia (Ramularia areola Atk.) (Tables 29, 30 and 31 below); Alternaria spot (Alternaria sp); Myrothecium (Myrothecium roridum); Rust (Phakopsora gossypii) (Puccinia cacabata).

The high efficacy of the synergistic interactions BF 452 (tebuconazole+carbendazim+kresoxim-methyl) and BF 465 (flutriafol+carbendazim+kresoxim-methyl) can also be observed in the control of coffee rust (Hemileia vastatrix) (Table 34 below) and Ascochyta spot (Table 35 below) and provide highly effective control of complex diseases in coffee crops.

The development of new products with the use of this synergistic action between molecules is an important component in the sustainability of production systems. Providing improved levels of control of plant diseases, control spectrum gains, greater difficulty for the emergence of fungicide resistance and greater safety regarding the use of fungicides.

### Example 16

### Efficacy of BF 488 and BF 489 in the Control of Phakopsora pachyrhizi Sydow in soybean crops, Santa Helena de Goiás/GO, 2009/2010 Crop

This study was conducted to evaluate the efficacy of the products in the control of Asian soybean rust. Preventive applications started in R1, with the second application occurring 20 days after the first application and the third application 15 days after the second. Emulsifiable mineral oil Assist was added, at the dose of 0.5% v/v in all treatments, except for the PrioriXtra treatments, in which 0.5% v/v Nimbus was added, and Fox, in which Aureo was added at the dose of 0.4 L/ha. Product BF 488 (tebuconazole 100+carbendazim 200+azoxystrobin 30) and product BF 489 (flutriafol 62.5+carbendazim 200+azoxystrobin 30) are effective in controlling soybean rust (Table 10 below), providing excellent residual control that can be observed by the smaller area under the disease-progress curve. The efficacy of BF 488 and BF 489 is consistent, reducing the disease throughout the soybean plant canopy. Analyzing the AUDPC of the bottom leaves, the best treatments were BF 488, BF 489, Fox and PrioriXtra, demonstrating higher mobility and/or higher residual efficacy of these fungicides. Analyzing the AUDPC of the top leaves, the best treatments were BF 488 and AproachPrima, demonstrating the high activity of these fungicides in controlling the disease. The best yields were observed in treatments with BF 488, BF 489, Opera, AproachPrima, and Fox. Tebuconazole applied alone was not effective in controlling soybean rust.

TABLE 10
Area under the disease-progress curve (AUDPC) and
yield in function of the interactions of fungicides for the control of Phakopsora
pachyrhizi Sydow, Santa Helena de Goiás-GO.

| Treatment | | | AUDPC | | | | | | | | Productivity | |
|---|---|---|---|---|---|---|---|---|---|---|---|---|
| No. | Name | Rate g ha⁻¹ a.i. | LEALOW | | LEAMID | | LEAUPP | | PLATOT | | kg ha⁻¹ | |
| 1 | UNTREATED | | 2557.5 | b | 2539.4 | a | 2312 | a | 2469.6 | a | [symbol] | f |
| 2 | ProductX | | 2310 | cde | 2158.1 | c | 1937.5 | c | 2135.2 | c | 1972.2 | de |
| 3 | ProductY | | 2355 | c | 2106.3 | cd | 1788.1 | cd | 2083.1 | c | 2208.3 | b-e |
| 4 | BF 488-01 | 100 + 200 + 30 | 2295 | def | 1968.8 | ef | 1493.3 | fg | 1919.0 | fg | 2736.1 | abc |
| 5 | BF 488-01 | 120 + 240 + 36 | 2242.5 | gh | 1925 | f | 1452.1 | g | 1873.2 | g | 3187.5 | a |
| 6 | PRIORI XTRA | 60 + 24 | 2257.5 | fgh | 1990.6 | ef | 1624.5 | ef | 1957.5 | def | 2500.0 | a-d |
| 7 | OPERA | 66.5 + 25 | 2317.5 | cde | 2036.9 | de | 1633.8 | ef | 1996.0 | de | 2986.1 | a |
| 8 | ProductZ | | 2272.5 | efg | 2170 | c | 1842.9 | cd | 2095.1 | c | 2118.1 | cde |
| 9 | BF 489-03 | 62.5 + 200 + 30 | 2257.5 | fgh | 2049.4 | de | 1734.3 | de | 2013.7 | d | 2854.2 | ab |
| 10 | APROACH PRIMA | 60 + 24 | 2272.5 | efg | 1949.4 | f | 1508 | fg | 1910.0 | fg | 2847.2 | ab |
| 11 | FOX | 60 + 70 | 2220 | h | 2043.1 | de | 1619.9 | ef | 1961.0 | def | 2680.6 | abc |
| 12 | FOLICUR | 100 | 2347.5 | c | 2342.5 | b | 2134.4 | b | 2274.8 | b | 1583.3 | ef |

| | | | | | |
|---|---|---|---|---|---|
| LSD (P = .05) | 44.3 | 77.5 | 145.3 | 67.9 | 608459.0 |
| CV | 1.3 | 2.5 | 5.7 | 2.3 | 18.3 |

* Addition of Assist (emusifiable mineral oil) 0.5% v/v in all treatments, except for treatment 6, in which 0.5% Nimbus was added, and treatment 11, in which 0.4 L/ha Aureo was added. [symbol]
indicates data missing or illegible when filed

### Example 17

### Efficacy of BF 452 and BF 465 in the Control of Phakopsora pachyrhizi Sydow in Soybean Crops. Rio Verde/GO, 2008/2009 Crop

This study was conducted to evaluate the efficacy of the products in the control of Asian soybean rust (Favorita). Preventive applications started in R1, the second application was made 19 days after the first (in R4) and the third application was made 15 days after the second (in R5.3). Emulsifiable mineral oil Assist was added at the dose of 0.5% v/v in all treatments, except for the PrioriXtra treatments, in which 0.5% v/v Nimbus was added. Product BF 452 (tebuconazole 100+carbendazim 200+kresoxim-methyl 125) and product BF 465 (flutriafol 62.5+carbendazim 200+kresoxim-methyl 125) are effective in controlling soybean rust (Table 11 below), providing excellent residual control that can be observed by the smaller area under the disease-progress curve. The efficacy of BF 452 and BF 465 is consistent, reducing the disease throughout the soybean plant canopy. Analyzing the AUDPC of the bottom leaves, the best treatments were BF 452, BF 465 and Opera, demonstrating higher mobility and/or higher residual efficacy of these fungicides. Analyzing the AUDPC of the top leaves, the best treatments were BF 452 and BF 465, demonstrating the high activity of these fungicides in controlling the disease. The best yields were observed in treatments with BF 452, BF 465 and PrioriXtra. Tebuconazole applied alone was not effective in controlling soybean rust.

TABLE 11
Area under the disease-progress curve (AUDPC) and yield in function of
the interactions of fungicides for the control of Phakopsora pachyrhizi, Rio Verde-GO.

| Treatment | | | AUDPC | | | | | | | | Productivity | |
|---|---|---|---|---|---|---|---|---|---|---|---|---|
| No. | Name | Rate g ha⁻¹ a.i. | LEALOW | | LEAMID | | LEAUPP | | PLATOT | | kg ha⁻¹ | |
| 1 | CHECK | | 1324.0 | a | 1130.9 | a | 545.0 | a | 1000.0 | a | 2014.1 | b |
| 2 | BF 465-03 | 62.5 + 200 + 125 | 609.2 | c | 402.0 | c | 20.0 | c | 343.7 | c | 2750.5 | a |
| 3 | ProductX | | 584.5 | cd | 378.6 | cd | 21.1 | c | 328.1 | cd | 2610.0 | a |
| 4 | ProductY | | 580.1 | cd | 341.2 | cde | 16.7 | c | 312.7 | cde | 2758.3 | a |
| 5 | BF 452-03 | 100 + 200 + 125 | 543.0 | cd | 321.9 | de | 17.5 | c | 294.1 | cde | 2731.2 | a |
| 6 | ProductT | | 519.0 | cd | 333.7 | cde | 14.5 | c | 289.1 | de | 2730.3 | a |
| 7 | ProductZ | | 504.5 | d | 283.9 | e | 11.1 | c | 266.5 | e | 2804.4 | a |
| 8 | PRIORI XTRA | 24 + 60 | 616.9 | c | 318.7 | de | 22.3 | c | 319.3 | cd | 2731.0 | a |
| 9 | OPERA | 25 + 66.5 | 593.2 | cd | 348.1 | cde | 33.5 | c | 324.9 | cd | 2606.3 | a |
| 10 | FOLICUR | 100 | 1014.4 | b | 584.9 | b | 89.5 | b | 562.9 | b | 2570.5 | a |

| | | | | | |
|---|---|---|---|---|---|
| CV (%) | 9.2 | 9.6 | 21.4 | 8.0 | 6.16 |

* Addition of Assist 0.5% v/v in all treatments.

### Example 18

### Efficacy of BF 452, BF 465, BF 488 and BF 489 in the Control of Phakopsora pachyrhizi Sydow in Soybean Crops, Goiänia/GO. 2009/2010 Crop

This study was conducted to evaluate the efficacy of the products in the control of Asian soybean rust (Valiosa). Preventive applications started in R1, the second application was made 19 days after the first (in R5.1) and the third application was made 15 days after the second (in R5.5). Emulsifiable mineral oil Assist was added at the dose of 0.5% v/v in all treatments, except for the PrioriXtra treatments, in which 0.5% v/v Nimbus was added. Product BF 452 (tebuconazole 100+carbendazim 200+kresoxim-methyl 125); product BF 488 (tebuconazole 100+carbendazim 200+azoxystrobin 30); product BF 465 (flutriafol 62.5+carbendazim 200+kresoxim-methyl 125) and product BF 489 (flutriafol 62.5+carbendazim 200+azoxystrobin 30) are effective in controlling soybean rust (Table 12 below), providing excellent residual control that can be observed by the smaller area under the disease-progress curve. The efficacy of BF 452, BF 465, BF 488 and BF 489 is consistent, reducing the disease throughout the soybean plant canopy. Analyzing the AUDPC of the bottom leaves, the best treatments were BF 452, BF 488, BF 489 and PrioriXtra, demonstrating higher mobility and/or higher residual efficacy of these fungicides. Analyzing the AUDPC of the top leaves, the best treatments were BF 452, BF 465, BF 488, BF 489, PrioriXtra and Opera, demonstrating the high activity of these fungicides in controlling the disease. The best yields were observed in treatments with BF 452, BF 465, BF 488, BF 489, Opera and PrioriXtra. Tebuconazole applied alone was not effective in controlling soybean rust.

TABLE 12
Area under the disease-progress curve (AUDPC) and yield in function of
the interactions of fungicides for the control of Phakopsora pachyrhizi Sydow, Goiânia-GO.

| Treatment | | | AUDPC | | | | | | | | Productivity | |
|---|---|---|---|---|---|---|---|---|---|---|---|---|
| No. | Name | Rate g ha⁻¹ a.i. | LEALOW | | LEAMID | | LEAUPP | | PLATOT | | kg ha⁻¹ | |
| 1 | CHECK | | 1737.4 | a | 1154.0 | a | 664.0 | a | 1185.1 | a | 2181.6 | b |
| 2 | ProductX | | 943.6 | c | 258.0 | c | 61.7 | c | 421.1 | c | 3390.3 | ab |
| 3 | BF 465-03 | 62.5 + 200 + 125 | 943.3 | c | 251.7 | c | 62.7 | c | 419.2 | c | 3447.8 | a |
| 4 | BF 489 | 62.5 + 200 + 30 | 560.6 | d | 197.9 | d | 62.2 | c | 273.6 | d | 3695.8 | a |
| 5 | ProductY | | 555.4 | d | 193.0 | d | 55.0 | cd | 267.8 | d | 3327.6 | ab |
| 6 | BF 452-03 | 100 + 200 + 125 | 566.8 | d | 187.7 | d | 50.5 | d | 268.4 | d | 3613.1 | a |
| 7 | BF 488 | 100 + 200 + 30 | 576.5 | d | 192.6 | d | 56.0 | cd | 275.0 | d | 3618.0 | a |
| 8 | PRIORI XTRA | 24 + 60 | 592.5 | d | 199.5 | d | 55.1 | cd | 282.3 | d | 3319.6 | ab |
| 9 | OPERA | 25 + 66.5 | 994.1 | c | 275.3 | c | 57.3 | cd | 442.2 | c | 3657.8 | a |
| 10 | FOLICUR | 100 | 1078.6 | b | 694.0 | b | 158.9 | b | 643.8 | b | 2987.8 | ab |

| | | | | | |
|---|---|---|---|---|---|
| CV (%) | 2.47 | 3.57 | 3.14 | 2.18 | 15.6 |

* Addition of Assist (emusifiable mineral oil) 0.5% v/v in all treatments.

### Example 19

### Efficacy of BF 488 in the control of Phakopsora Pachyrhizi Sydow in Soybean Crops, Goiânia/GO, 2009/2010 Crop

This study was conducted to evaluate the efficacy of the products in the control of Asian rust. The start of preventive applications in V9, the second application was made 20 days after the first (in R4) and the third application was made 15 days after the second. Emulsifiable mineral oil Assist was added, at the dose of 0.5% v/v in all treatments, except for the PrioriXtra treatments, in which 0.5% v/v Nimbus was added, and Fox, in which Aureo was added at the dose of 0.4 L/ha. Product BF 488 (tebuconazole 100+carbendazim 200+azoxystrobin 30) and product BF 489 (flutriafol 62.5+carbendazim 200+azoxystrobin 30) are effective in controlling soybean rust (Table 13 below), providing excellent residual control that can be observed by the smaller area under the disease-progress curve. The efficacy of BF 488 and BF 489 is consistent, reducing the disease throughout the soybean plant canopy. Analyzing the AUDPC of the bottom leaves, the best treatments were BF 488, BF 489, Fox and ApproachPrima, demonstrating higher mobility and/or higher residual efficacy of these fungicides. Analyzing the AUDPC of the top leaves, the best treatments were BF 488, BF 489 and AproachPrima, demonstrating the high activity of these fungicides in controlling the disease. The best yields were observed in treatments with BF 488, BF 489, Opera, PrioriXtra, Opera, AproachPrima and Fox. Tebuconazole applied alone was not effective in controlling soybean rust.

TABLE 13
Area under the disease-progress curve (AUDPC) and yield in function of
the interactions of fungicides for the control of Phakopsora pachyrhizi Sydow, Goiânia-GO.

| Treatment | | | AUDPC | | | | | | | | Productivity | |
|---|---|---|---|---|---|---|---|---|---|---|---|---|
| No. | Name | Rate g ha⁻¹ a.i. | LEALOW | | LEAMID | | LEAUPP | | PLATOT | | kg ha⁻¹ | |
| 1 | UNTREATED | | 3472.5 | a | 2725.0 | a | 2099.8 | a | 2765.8 | a | 2018.5 | f |
| 2 | ProductX | | 2212.3 | ef | 1422.8 | de | 852.8 | e | 1495.9 | e | 2296.3 | ef |
| 3 | ProductY | | 2248.3 | e | 1313.6 | fg | 879.6 | e | 1480.5 | ef | 3388.9 | a-d |
| 4 | BF 488-01 | 100 + 200 + 30 | 2195.8 | ef | 1216.5 | h | 747.5 | gh | 1386.6 | g | 3731.5 | ab |
| 5 | BF 488-01 | 120 + 240 + 36 | 2105.8 | gh | 1205.0 | h | 752.5 | gh | 1354.4 | gh | 3902.8 | a |
| 6 | PRIORI XTRA | 60 + 24 | 2210.1 | ef | 1324.8 | fg | 828.1 | ef | 1454.3 | ef | 3463.0 | abc |
| 7 | OPERA | 66.5 + 25 | 2196.4 | ef | 1264.5 | gh | 845.3 | e | 1435.4 | f | 3226.9 | a-e |
| 8 | ProductZ | | 2232.3 | ef | 1374.0 | ef | 850.6 | e | 1485.6 | e | 3430.6 | abc |
| 9 | BF 489-03 | 62.5 + 200 + 30 | 2227.5 | ef | 1345.0 | f | 785.7 | fg | 1452.7 | ef | 3740.7 | ab |
| 10 | APROACH PRIMA | 60 + 24 | 2047.8 | h | 1133.1 | i | 638.4 | i | 1273.1 | i | 3324.1 | a-d |
| 11 | FOX | 60 + 70 | 2079.6 | gh | 1460.5 | d | 867.6 | e | 1469.2 | ef | 3893.5 | a |
| 12 | FOLICUR | 100 | 2435.4 | d | 1888.1 | c | 1370.9 | d | 1898.1 | d | 2763.9 | b-f |

| | | | | | |
|---|---|---|---|---|---|
| LSD (P = .05) | 75.6 | 70.9 | 55.5 | 43.7 | 852533.0 |
| CV | 2.3 | 3.3 | 3.8 | 1.9 | 18.3 |

* Addition of Assist (emusifiable mineral oil) 0.5% v/v in all treatments, except for treatment 6, in which 0.5% Nimbus was added, and treatment 11, in which 0.4 L/ha Áureo was added.

### Example 20

### Efficacy of BF 488 in the control of Phakopsora Septoria Glycines in Soybean Crops, Goiânia/GO, 2009/2010 Crop

This study was conducted to evaluate the efficacy of the products in the control of soybean septoriosis. It was installed in soybean inox TMG 801 to avoid the interference of soybean rust in the assessment of the experiment. Preventive fungicide applications started in R1, and the second application was made 21 days after the first. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30) is effective in controlling Septoria glycines (Table 14 below), providing excellent residual control that can be observed by the smaller area under the disease-progress curve. The efficacy of BF 488 is consistent, reducing the disease throughout the soybean plant canopy. Disease severity was high as can be observed in the untreated control with 54% severity 48 days after the second application (DA2A). Analyzing the severity of septoriosis at 17 DA2A, the best treatments were BF 488, and PrioriXtra and PrioriXtra+Portero. However, in the assessment of severity at 58 DA2A, BF 488 maintains better control. The better control efficacy and the maintenance of a residual effect of BF 488 can be observed in the lower AUPDC values.

TABLE 14
Area under the disease-progress curve (AUDPC) and
severity in function of the interactions of fungicides for the control of Septoria glycines, Goiânia-GO.

| Treatment | | | Septoria glycines (Severity %) | | | | | | | | | | AUPDC | |
|---|---|---|---|---|---|---|---|---|---|---|---|---|---|---|
| No. | Name | Rate g ha⁻¹ a.i. | 17DA2A | | 29DA2A | | 37DA2A | | 48DA2A | | 58DA2A | | SEPTGL | |
| 1 | UNTREATED | | 16 | a | 19 | a | 28 | a | 54 | a | 58 | a | 1403.1 | a |
| 2 | BF 488-01 | 100 + 200 + 30 | 5 | bcd | 9 | cd | 13 | d | 17 | c | 38 | bc | 597.1 | f |
| 3 | BF 488-01 | 120 + 240 + 36 | 5 | cd | 9 | cd | 14 | cd | 14 | c | 41 | bc | 598.5 | f |
| 4 | PORTERO | 400 | 7 | b | 9 | cd | 13 | d | 24 | b | 38 | bc | 681.1 | de |
| 5 | PRIORI XTRA | 60 + 24 | 5 | bcd | 9 | cd | 15 | bcd | 23 | b | 43 | bc | 706.3 | cd |
| 6 | PRIORI XTRA + PORTERO | 60 + 24 + 400 | 5 | cd | 10 | c | 19 | b | 26 | b | 44 | b | 797.1 | b |

| | | | | | | |
|---|---|---|---|---|---|---|
| LSD (P = .05) | 1.9 | 2.5 | 3.5 | 4.9 | 6 | 79.57 |
| CV | 22.34 | 17.01 | 15.38 | 14.57 | 9.51 | 7.31 |

### Example 21

### Efficacy of BF 488 in the Control of Cercospora Kikuchii in Soybean Crops, Goiânia/GO, 2009/2010 Crop

This study was conducted to evaluate the efficacy of the products in the control of soybean cercosporiosis. It was installed in soybean inox TMG 801 to avoid the interference of soybean rust in the assessment of the experiment. Preventive fungicide applications started in R1, and the second application was made 21 days after the first. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30) is effective in controlling Cercospora kikuchii (Table 15 below), providing excellent residual control that can be observed by the smaller area under the disease-progress curve. The efficacy of BF 488 is consistent, reducing the disease throughout the soybean plant canopy. Disease severity was high as can be observed in the untreated control with 29% severity 48 days after the second application (DA2A). Analyzing the severity of cercosporiosis at 29 DA2A, the best treatments were BF 488, Portero, PrioriXtra and PrioriXtra+Portero. However, in the assessment of severity at 58 DA2A, BF 488 has better control. The better control efficacy and the maintenance of a residual effect of BF 488 can be observed in the lower AUPDC values.

TABLE 15
Area under the disease-progress curve (AUDPC) and
severity in function of the interactions of fungicides for the control of Cercospora kikuchii, Goiânia-GO.

| Treatment | | | Cercospora kikuchii (Severity %) | | | | | | | | | | AUPDC | |
|---|---|---|---|---|---|---|---|---|---|---|---|---|---|---|
| No. | Name | Rate g ha⁻¹ a.i. | 17DA2A | | 29DA2A | | 37DA2A | | 48DA2A | | 58DA2A | | CERCKI | |
| 1 | UNTREATED | | 3 | a | 7 | a | 13 | a | 21 | a | 29 | a | 576.9 | a |
| 2 | BF 488-01 | 100 + 200 + 30 | 0 | c | 3 | e | 6 | d | 6 | ef | 12 | cd | 198.8 | ef |
| 3 | BF 488-01 | 120 + 240 + 36 | 2 | b | 4 | de | 4 | e | 4 | fg | 13 | bcc | 177.8 | ef |
| 4 | PORTERO | 400 | 0 | c | 5 | b | 8 | bc | 9 | bc | 16 | b | 299.8 | bc |
| 5 | PRIORI XTRA | 60 + 24 | 0 | c | 5 | b | 7 | cd | 9 | cd | 13 | bcc | 269.8 | cd |
| 6 | PRIORI XTRA + PORTERO | 60 + 24 + 400 | 0 | c | 5 | b | 9 | b | 11 | b | 15 | bc | 328.5 | b |

| | | | | | | |
|---|---|---|---|---|---|---|
| LSD (P = .05) | 1.1 | 0.9 | 1.6 | 2.4 | 3.3 | 43.97 |
| CV | 151.05 | 13.87 | 16.31 | 20.03 | 15.3 | 11.23 |

### Example 22

### Efficacy of BF 452 and BF 488 in the Control of Sclerotinia sclerotiorum in Soybean Crops, Barreiras/BA, 2009/2010 Crop

The test was conducted in randomized blocks design, with four replications. This was carried out in Barreiras-BA, in the 2009/2010 crop, in cultivar M-Soy 9144RR. The start of fungicide application occurred 25 days after crop emergence (DAE), with the second application occurring 35 DAE and the third application 15 days afterwards in R2. Analyzing the incidence of white mold at 95 DAE, fungicides BF 488 (tebuconazole 100+carbendazim 200+azoxystrobin 30), BF 452 (tebuconazole 100+carbendazim 200+kresoxim-methyl 125), Frowncide and Sumilex were effective in controlling the disease, and do not show any differences (Table 16 below). However, analyzing the soybean yield, it is noted that there is no difference between these fungicides, and that they were effective in controlling Sclerotinia sclerotiorum in soybean crops.

TABLE 16
Incidence and severity of Sclerotinia sclerotiorum in
soybean crops and productivity in function of the interactions of fungicides, Barreiras, BA.

| Treatment | | | Sclerotinia sclerotiorum | | | | | | Productivity | |
|---|---|---|---|---|---|---|---|---|---|---|
| No. | Name | Rate g ha⁻¹ a.i. | Incidence 75DAE | | Incidence 95DAE | | Severity 95DAE | | kg ha⁻¹ | |
| 1 | UNTREATED | | 1 | a | 3 | a | 77.5 | a | 1825.9 | a |
| 2 | BF 452-07 | 100 + 200 + 125 | 0 | a | 2 | ab | 63.8 | a | 2577.8 | a |
| 3 | BF 452-07 | 200 + 400 + 250 | 0 | a | 1 | bc | 26.3 | a | 2690.7 | a |
| 4 | BF 488-01 | 100 + 200 + 30 | 0 | a | 1 | bc | 47.5 | a | 2816.7 | a |
| 5 | BF 488-01 | 200 + 400 + 60 | 0 | a | 0 | c | 20.0 | a | 3001.9 | a |
| 6 | FROWNCIDE | 500 | 0 | a | 1 | bc | 42.5 | a | 2327.8 | a |
| 7 | SUMILEX 500 WP | 500 | 0 | a | 1 | bc | 40.0 | a | 2877.8 | a |

| | | | | |
|---|---|---|---|---|
| LSD (P = .05) | 0.61 | 1.2 | 53.06 | 843.317 |
| CV | 295.81 | 70.91 | 78.74 | 21.93 |

### Example 23

### Efficacy of BF 488 in the control of Puccinia sorghi e Colletotrichum graminicola in Corn Crops, Sáo Desidério/BA, 2009/2010 Crop

This study was conducted to evaluate the efficacy of the products in the control of common rust and anthracnose in corn crops. It was installed in corn DKB 390 YG. Preventive fungicide applications started on the 5^{th} leaf, and the second application was made before corn tasseling. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30) and product BF 489 (flutriafol 62.5+carbendazim 200+azoxystrobin 30) are effective in controlling Puccinia sorghi and Colletotrichum graminicola (Tabela 17), providing excellent residual control that can be observed by the smaller area under the disease-progress curve. The efficacy of BF 488 and BF 489 is consistent, reducing the disease throughout the corn plant canopy. Disease severity was high as can be observed in the untreated control by the large area under the disease-progress curve, which resulted in lower productivity.

TABLE 17
Area under the disease-progress curve (AUDPC) and yield in function of
the interactions of fungicides for the control of Puccinia sorghi and Colletotrichum graminicola in corn crops, São Desidério-BA.

| | | | | | | | | | | | AUDPC- | | | | | |
|---|---|---|---|---|---|---|---|---|---|---|---|---|---|---|---|---|
| Treatment | | | AUDPC-Puccinio sorghi | | | | | | | | C. graminicola | | Mass (g) | | Productivity | |
| No. | Name | Rate g ha⁻¹ a.i. | LEALOW | | LEAMID | | LEAUPP | | PLATOT | | PLATOT | | 1000 grain | | kg ha ⁻¹ | |
| 1 | UNTREATED | | 3301.5 | a | 2000.3 | a | 862.4 | a | 2054.7 | a | 1756.9 | a | 330.0 | bc | 10792.5 | a |
| 2 | ProductX | | 1629.0 | b | 1060.5 | bc | 647.1 | bc | 1112.2 | b | 875.2 | b | 337.5 | bc | 12540.0 | a |
| 3 | ProductY | | 1578.4 | b | 1090.3 | b | 622.3 | cd | 1096.9 | b | 881.5 | b | 332.5 | bc | 12685.0 | a |
| 4 | BF 488-01 | 100 + 200 + 30 | 1286.4 | c | 884.5 | d | 571.4 | de | 914.1 | c | 653.1 | cd | 347.5 | abc | 13877.5 | a |
| 5 | BF 488-01 | 120 + 240 + 36 | 1158.7 | cd | 889.9 | d | 584.3 | de | 877.6 | cd | 595.5 | de | 337.5 | bc | 14215.0 | a |
| 6 | PRIORI XTRA | 60 + 24 | 797.5 | e | 671.3 | e | 487.4 | f | 652.1 | e | 396.0 | f | 382.5 | a | 14252.5 | a |
| 7 | OPERA | 99.8 + 37.5 | 986.3 | d | 837.9 | d | 544.3 | e | 789.5 | d | 524.6 | e | 357.5 | abc | 14045.0 | a |
| 8 | ProductZ | | 1614.4 | b | 1102.2 | b | 661.3 | bc | 1126.0 | b | 874.3 | b | 327.5 | c | 12645.0 | a |
| 9 | ProductT | | 1724.2 | b | 1128.8 | b | 677.0 | b | 1176.6 | b | 933.5 | b | 342.5 | bc | 11515.0 | a |
| 10 | BF 489-03 | 62.5 + 200 + 30 | 1260.6 | c | 933.2 | cd | 609.5 | cd | 934.4 | c | 733.8 | c | 367.5 | ab | 13810.0 | a |

| | | | | | | | |
|---|---|---|---|---|---|---|---|
| LSD (P = .05) | 185.14 | 130.95 | 48.64 | 96.96 | 106.49 | 32.741 | 2.472.889 |
| CV | 8.32 | 8.52 | 5.35 | 6.23 | 8.92 | 6.52 | 13.07 |

* Emulsifiable mineral oil Assist was added, at the dose of 0.5% v/v in all treatments, except for the PrioriXtra treatments, in which 0.5% v/v Nimbus was added.

### Example 24

### Efficacy of BF 488 in the Control of Physophella zeae in Corn Crops, Goiânia/GO, 2009/2010 Crop

This study was conducted to evaluate the efficacy of the products in the control of tropical rust in corn crops. It was installed in corn DKB 390 YG. Preventive fungicide applications started on the 5^{th} leaf, and the second application was made before corn tasseling. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30) is effective in controlling Physopella zeae (Table 18 below), providing excellent residual control that can be observed by the smaller area under the disease-progress curve. The efficacy of BF 488 is consistent, reducing the disease throughout the corn plant canopy. Disease severity was high as can be observed in the untreated control by the large area under the disease-progress curve, which resulted in lower productivity.

TABLE 18
Area under the disease-progress curve (AUDPC) in function of the interactions of
fungicides for the control of Physopella zeae in corn crops, Goiânia-GO.

| Treatment | | | AUDPC-Physopella zeae | | | | | | | |
|---|---|---|---|---|---|---|---|---|---|---|
| No. | Name | Rate g ha⁻¹ a.i. | LEALOW | | LEAMID | | LEAUPP | | PLATOT | |
| 1 | UNTREATED | | 1783.1 | a | 1494.4 | a | 1090.0 | a | 1455.8 | a |
| 2 | BF 488-01 | 100 + 200 + 30 | 985.5 | d | 495.6 | d | 396.9 | bcd | 626.0 | cd |
| 3 | BF 488-01 | 120 + 240 + 36 | 929.1 | de | 492.8 | d | 377.9 | cd | 599.9 | d |
| 4 | PRIORI XTRA | 60 + 24 | 828.6 | f | 399.3 | e | 268.0 | e | 498.6 | e |
| 5 | OPERA | 99.8 + 37.5 | 897.5 | ef | 483.8 | d | 338.5 | d | 573.3 | d |

| | | | | |
|---|---|---|---|---|
| LSD (P = .05) | 79.91 | 58.06 | 57.1 | 510.08 |
| CV | 8.95 | 8.97 | 5.6 | 46.68 |

* Emulsifiable mineral oil Assist was added, at the dose of 0.5% v/v in all treatments, except for the PrioriXtra treatments, in which 0.5% v/v Nimbus was added.

### Example 25

### Efficacy of BF 488 in the control of Colletotrichum Graminicola in Corn Crops, Goiânia/GO, 2009/2010 Crop

This study was conducted to evaluate the efficacy of the products in the control of anthracnose in corn crops. It was installed in corn DKB 390 YG. Preventive fungicide applications started on the 5^{th} leaf, and the second application was made before corn tasseling. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30) is effective in controlling Colletotrichum graminicola (Table 19 below), providing excellent residual control that can be observed by the smaller area under the disease-progress curve. The efficacy of BF 488 is consistent, reducing the disease throughout the corn plant canopy. Disease severity was high as can be observed in the untreated control by the large area under the disease-progress curve, which resulted in lower productivity. BF 488 is effective in controlling C. graminicola.

TABLE 19
Area under the disease-progress curve (AUDPC) and
yield in function of the interactions of fungicides for the control of
Colletotrichum graminicola in corn crops, Goiânia-GO.

| Treatment | | | AUDPC-Colletotrichum graminicola | | | | | | | | Productivity | |
|---|---|---|---|---|---|---|---|---|---|---|---|---|
| No. | Name | Rate g ha⁻¹ a.i. | LEALOW | | LEAMID | | LEAUPP | | PLATOT | | kg ha⁻¹ | |
| 1 | UNTREATED | | [symbol] | a | 1633.8 | a | 846.9 | a | [symbol] | a | [symbol] | e |
| 2 | BF 488-01 | 100 + 200 + 30 | 1035.6 | ef | 509.6 | d | 278.9 | ef | 608.0 | d | 8537.0 | abc |
| 3 | BF 488-01 | 120 + 240 + 36 | 1025.0 | f | 493.0 | d | 296.1 | def | 604.7 | d | 9058.6 | ab |
| 4 | PRIORI XTRA | 60 + 24 | 1029.4 | ef | 373.4 | e | 249.8 | f | 550.8 | e | 8213.0 | a-d |
| 5 | OPERA | 99.8 + 37.5 | 1096.3 | d [symbol] | 453.6 | de | 302.8 | c-f | 617.5 | cd | 9713.0 | a |

| | | | | | |
|---|---|---|---|---|---|
| LSD (P = .05) | 62.11 | 80.97 | 50.23 | 49.99 | 1.495.786 |
| CV | 3.58 | 8.82 | 9.62 | 4.72 | 12.76 |

* Emulsifiable mineral oil Assist was added, at the dose of 0.5% v/v in all treatments, except for the PrioriXtra treatments, in which 0.5% v/v Nimbus was added. [symbol]
indicates data missing or illegible when filed

### Example 26

### Efficacy of BF 488 in the Control of Puccinia Polysora in Corn Crops, GoiâNia/GO, 2009/2010 Crop

This study was conducted to evaluate the efficacy of the products in the control of Southern rust in corn crops. It was installed in corn DKB 390 YG. Preventive fungicide applications started on the 5^{th} leaf, and the second application was made before corn tasseling. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30) is effective in controlling Puccinia polysora (Table 20 below), providing excellent residual control that can be observed by the smaller area under the disease-progress curve. The efficacy of BF 488 is consistent, reducing the disease throughout the corn plant canopy. Disease severity was high as can be observed in the untreated control by the large area under the disease-progress curve, which resulted in lower productivity.

TABLE 20
Area under the disease-progress curve (AUDPC) and
yield in function of the interactions of fungicides for the control of Puccinia
polysora in corn crops, Goiânia-GO.

| Treatment | | | AUDPC-Puccinia polysora | | | | | | | |
|---|---|---|---|---|---|---|---|---|---|---|
| No. | Name | Rate g ha⁻¹ a.i. | LEALOW | | LEAMID | | LEAUPP | | PLATOT | |
| 1 | UNTREATED | | 1860.0 | a | 1411.3 | a | 1032.5 | a | 1434.6 | a |
| 2 | BF 488-01 | 100 + 200 + 30 | 976.9 | cde | 496.1 | fg | 382.0 | de | 618.3 | c |
| 3 | BF 488-01 | 120 + 240 + 36 | 950.3 | def | 505.4 | fg | 353.4 | e | 603.0 | c |
| 4 | PRIORI XTRA | 60 + 24 | 864.8 | f | 309.0 | h | 259.0 | f | 477.6 | d |
| 5 | OPERA | 99.8 + 37.5 | 939.4 | def | 447.1 | g | 320.6 | e | 569.0 | c |

| | | | | |
|---|---|---|---|---|
| LSD (P = .05) | 79.9 | 84.42 | 61.71 | 50.1 |
| CV | 5.23 | 9.35 | 9.53 | 4.88 |

* Emulsifiable mineral oil Assist was added, at the dose of 0.5% v/v in all treatments, except for the PrioriXtra treatments, in which 0.5% v/v Nimbus was added.

### Example 27

### Efficacy of BF 452, BF 465, BF 489 and BF 488 in the Control of Cercospora zeae-Maydis, Helminthosporium Maydis, Puccinia Sorghi and Phaeosphaeria maydis in Corn Crops. Summary of the Three Studies. Santa Helena De Goiás/GO, 2009/2010 Crop

These studies were conducted to evaluate the efficacy of the prodcuts in the control of common rust, cercoporiosis, helmintosporiosis e phaeospharia spot in corn crops. They were installed in corn DKB 390 YG. Preventive fungicide applications started on the 5^{th} leaf, and the second application was made before corn tasseling. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30); product BF 489 (flutriafol 62.5+carbendazim 200+azoxystrobin 30); product BF 452 (tebuconazole 100+carbendazim 200+kresoxim-methyl 125) and product BF 465 (flutriafol 62.5+carbendazim 200+kresoxim-methyl 125) are effective in controlling Cercospora zeae-maydis, Helminthosporium maydis, Puccinia sorghi and Phaeosphaeria maydis (Tables 21, 22, 23 and 24 below), providing excellent residual control that can be observed by the smaller area under the disease-progress curve. The efficacy of BF 488, BF 489, BF 452 and BF 465 is consistent, reducing the disease throughout the corn plant canopy. Disease severity was high as can be observed in the untreated control by the large area under the disease-progress curve, which resulted in lower productivity. The efficacy of products BF 488, BF 489, BF 452 and BF 465 is consistent, improving corn productivity.

TABLE 21
Area under the disease-progress curve (AUDPC) and
yield in function of the interactions of fungicides for the control of Cercospora
zeae-maydis in corn crops, Santa Helena de Goiás-GO.

| Treatment | | | Cercospora zeae-maydis-AUPDC | | | | | | | | Produtividade | |
|---|---|---|---|---|---|---|---|---|---|---|---|---|
| No. | Name | Rate g ha⁻¹ a.i. | LEALOW | | LEAMID | | LEAUPP | | PLATOT | | kg ha⁻¹ | |
| 1 | CHECK | | 429.0 | a | 215.8 | a | 141.0 | a | 262.0 | a | 6482.6 | c |
| 2 | BF 465-03 | 62.5 + 200 + 125 | 176.8 | b | 61.3 | c | 15.0 | c | 84.3 | bc | 8229.2 | abc |
| 3 | ProductX | | 167.0 | b | 81.3 | bc | 18.0 | c | 88.8 | bc | 8399.3 | ab |
| 4 | BF 489 | 62.5 + 200 + 30 | 175.8 | b | 64.8 | bc | 18.3 | c | 86.0 | bc | 8370.1 | ab |
| 5 | BF 452-03 | 100 + 200 + 125 | 150.8 | b | 63.0 | bc | 18.3 | c | 77.0 | bc | 8729.2 | a |
| 6 | ProductY | | 178.5 | b | 85.5 | bc | 20.5 | c | 94.8 | bc | 7938.9 | abc |
| 7 | BF 488 | 100 + 200 + 30 | 186.0 | b | 92.8 | b | 35.0 | b | 104.5 | b | 8166.7 | abc |
| 8 | PRIORI XTRA | 24 + 60 | 213.0 | b | 66.5 | bc | 21.5 | c | 100.0 | bc | 8395.9 | ab |
| 9 | OPERA | 99.8 + 37.5 | 151.8 | b | 70.0 | bc | 7.5 | d | 76.0 | c | 8354.2 | abc |
| 10 | FOLICUR | 100 | 198.0 | b | 63.8 | bc | 5.0 | d | 88.8 | bc | 6724.3 | bc |

| | | | | | |
|---|---|---|---|---|---|
| CV (%) | 13.07 | 14.29 | 10.25 | 10.67 | 9.69 |

* Emulsifiable mineral oil Assist was added, at the dose of 0.5% v/v in all treatments, except for the PrioriXtra treatments, in which 0.5% v/v Nimbus was added.

TABLE 22
Area under the disease-progress curve (AUDPC) and
yield in function of the interactions of fungicides for the control of
Helminthosporium maydis in corn crops, Santa Helena de Goiás-GO.

| Treatment | | | Helminthosporium maydis-AUPDC | | | | | | | |
|---|---|---|---|---|---|---|---|---|---|---|
| No. | Name | Rate g ha⁻¹ a.i. | LEALOW | | LEAMID | | LEAUPP | | PLATOT | |
| 1 | CHECK | | 400.0 | a | 234.8 | a | [symbol] | a | 233.0 | a |
| 2 | BF 465-03 | 62.5 + 200 + 125 | 131.0 | bc | 57.3 | cd | 25.0 | b | 70.5 | c |
| 3 | ProductX | | 130.0 | bc | 60.5 | cd | 25.0 | b | 71.5 | c |
| 4 | BF 489 | 62.5 + 200 + 30 | 125.3 | c | 60.5 | cd | 25.0 | b | 70.0 | c |
| 5 | BF 452-03 | 100 + 200 + 125 | 122.8 | c | 61.8 | cd | 20.0 | bc | 67.8 | cd |
| 6 | ProductY | | 130.0 | bc | 63.0 | c | 23.0 | b | 71.8 | c |
| 7 | BF 488 | 100 + 200 + 30 | 117.8 | c | 62.3 | c | 21.0 | b | 66.8 | cd |
| 8 | PRIORI XTRA | 24 + 60 | 123.8 | c | 55.5 | cd | 15.0 | bc | 64.3 | cd |
| 9 | OPERA | 99.8 + 37.5 | 122.8 | c | 50.8 | d | 10.0 | c | 61.0 | d |
| 10 | FOLICUR | 100 | 158.0 | b | 85.5 | b | 10.0 | c | 84.3 | b |

| | | | | |
|---|---|---|---|---|
| CV (%) | 8.09 | 5.77 | 17.99 | 3.95 |

* Emulsifiable mineral oil Assist was added, at the dose of 0.5% v/v in all treatments, except for the PrioriXtra treatments, in which 0.5% v/v Nimbus was added. [symbol]
indicates data missing or illegible when filed

TABLE 23
Area under the disease-progress curve (AUDPC) and
yield in function of the interactions of fungicides for the control of Puccinia
sorghi in corn crops, Santa Helena de Goiás-GO.

| Treatment | | | Puccinia sorghi-AUPDC | | | | | | | |
|---|---|---|---|---|---|---|---|---|---|---|
| No. | Name | Rate g ha⁻¹ a.i. | LEALOW | | LEAMID | | LEAUPP | | PLATOT | |
| 1 | CHECK | | 792.8 | a | 523.3 | a | 155.8 | a | 490.5 | a |
| 2 | BF 465-03 | 62.5 + 200 + 125 | 229.8 | c | 209.3 | cde | 26.0 | bc | 154.8 | c |
| 3 | ProductX | | 207.0 | c | 172.3 | cde | 22.5 | c | 133.8 | c |
| 4 | BF 489 | 62.5 + 200 + 30 | 197.5 | c | 119.3 | e | 19.0 | c | 111.8 | c |
| 5 | BF 452-03 | 100 + 200 + 125 | 233.3 | c | 255.3 | bc | 33.3 | bc | 173.8 | c |
| 6 | ProductY | | 229.8 | c | 169.5 | cde | 33.0 | bc | 143.8 | c |
| 7 | BF 488 | 100 + 200 + 30 | 204.3 | c | 241.5 | bcd | 32.8 | bc | 159.3 | c |
| 8 | PRIORI XTRA | 24 + 60 | 233.5 | c | 182.5 | cde | 28.0 | bc | 148.0 | c |
| 9 | OPERA | 99.8 + 37.5 | 238.5 | c | 136.0 | de | 17.5 | c | 130.5 | c |
| 10 | FOLICUR | 100 | 472.0 | b | 338.3 | b | 40.8 | b | 283.5 | b |

| | | | | |
|---|---|---|---|---|
| CV (%) | 14.24 | 18.98 | 18.24 | 13.75 |

* Emulsifiable mineral oil Assist was added, at the dose of 0.5% v/v in all treatments, except for the PrioriXtra treatments, in which 0.5% v/v Nimbus was added.

TABLE 24
Area under the disease-progress curve (AUDPC) and
yield in function of the interactions of fungicides for the control of
Phaeosphaeria maydis in corn crops, Santa Helena de Goiás-GO.

| Treatment | | | Phaeosphaeria maydis-AUPDC | | | | | | | |
|---|---|---|---|---|---|---|---|---|---|---|
| No. | Name | Rate g ha⁻¹ a.i. | LEALOW | | LEAMID | | LEAUPP | | PLATOT | |
| 1 | CHECK | | 1204.0 | a | 760.5 | a | 411.3 | a | 791.5 | a |
| 2 | BF 465-03 | 62.5 + 200 + 125 | 424.0 | b | 284.8 | b | 125.5 | b | 278.0 | b |
| 3 | ProductX | | 417.3 | b | 312.0 | b | 125.5 | b | 284.8 | b |
| 4 | BF 489 | 62.5 + 200 + 30 | 404.8 | b | 250.0 | b | 110.0 | b | 254.8 | b |
| 5 | BF 452-03 | 100 + 200 + 125 | 390.0 | b | 278.8 | b | 124.3 | b | 264.0 | b |
| 6 | ProductY | | 376.5 | b | 287.5 | b | 116.0 | b | 260.0 | b |
| 7 | BF 488 | 100 + 200 + 30 | 402.3 | b | 312.3 | b | 134.3 | b | 283.0 | b |
| 8 | PRIORI XTRA | 24 + 60 | 408.0 | b | 262.0 | b | 115.8 | b | 261.8 | b |
| 9 | OPERA | 99.8 + 37.5 | 384.5 | b | 290.3 | b | 146.0 | b | 273.5 | b |
| 10 | FOLICUR | 100 | 406.5 | b | 274.5 | b | 136.0 | b | 272.3 | b |

| | | | | |
|---|---|---|---|---|
| CV (%) | 12.56 | 10.01 | 12.06 | 8.93 |

* Emulsifiable mineral oil Assist was added, at the dose of 0.5% v/v in all treatments, except for the PrioriXtra treatments, in which 0.5% v/v Nimbus was added.

### Example 28

### Efficacy of BF 452, BF 465, BF 489 and BF 488 in the Control of Colletotrichum graminicola in Corn Crops, Luis Eduardo Magalhaes/BA, 2009/2010 Crop

This study was conducted to evaluate the efficacy of the prodcuts in the control of anthracnose in corn crops. They were installed in corn DKB 390 YG. Preventive fungicide applications started on the 5^{th} leaf, and the second application was made before corn tasseling. Emulsifiable mineral oil Assist was added at the dose of 0.5% v/v in all treatments, except for the PrioriXtra treatments, in which 0.5% v/v Nimbus was added. Product BF 488 (tebuconazole 100+carbendazim 200+azoxystrobin 30); product BF 489 (flutriafol 62.5+carbendazim 200+azoxystrobin 30); product BF 452 (tebuconazole 100+carbendazim 200+kresoxim-methyl 125); and product BF 465 (flutriafol 62.5+carbendazim 200+kresoxim-methyl 125) are effective in controlling Colletotrichum graminicola (Table 25 below), providing excellent residual control that can be observed by the smaller area under the disease-progress curve. The efficacy of BF 488, BF 489, BF 452 and BF 465 is consistent, reducing the disease throughout the corn plant canopy. Disease severity was high as can be observed in the untreated control by the large area under the disease-progress curve, which resulted in lower productivity. The efficacy of products BF 488, BF 489, BF 452 and BF 465 is consistent, improving corn productivity.

TABLE 25
Area under the disease-progress curve (AUDPC) and
yield in function of the interactions of fungicides for the control of
Colletotrichum graminicola in corn crops, Luis Eduardo Magalhães-BA.

| Treatment | | | Colletotrichum graminicola-AUPDC | | | | | | Productivity | |
|---|---|---|---|---|---|---|---|---|---|---|
| No. | Name | Rate g ha⁻¹ a.i. | LEALOW | | LEAMID | | LEAUPP | | kg ha⁻¹ | |
| 1 | CHECK | | 2553.4 | a | 732.0 | a | 162.8 | a | 7013.89 | b |
| 2 | BF 465-03 | 62.5 + 200 + 125 | 1471.5 | bc | 286.0 | b | 64.8 | b | 8861.11 | ab |
| 3 | ProductX | | 1439.3 | bc | 240.5 | b | 52.0 | b | 9157.41 | ab |
| 4 | BF 489 | 62.5 + 200 + 30 | 1322.0 | c | 135.3 | b | 25.1 | b | 9476.85 | a |
| 5 | BF 452-03 | 100 + 200 + 125 | 1503.3 | bc | 289.8 | b | 68.3 | b | 9342.59 | a |
| 6 | ProductY | | 1347.6 | bc | 226.3 | b | 42.8 | b | 8425.93 | ab |
| 7 | BF 488 | 100 + 200 + 30 | 1335.3 | bc | 253.8 | b | 80.3 | b | 9189.82 | ab |
| 8 | PRIORI XTRA | 24 + 60 | 1526.4 | bc | 321.0 | b | 49.6 | b | 9671.3 | a |
| 9 | OPERA | 99.8 + 37.5 | 1631.1 | bc | 342.8 | b | 66.5 | b | 9208.33 | ab |
| 10 | FOLICUR | 100 | 1698.5 | b | 430.0 | b | 89.3 | ab | 7925.93 | ab |

| | | | | |
|---|---|---|---|---|
| CV (%) | 9.69 | 37.31 | 43.1 | 10.81 |

* Emulsifiable mineral oil Assist was added, at the dose of 0.5% v/v in all treatments, except for the PrioriXtra treatments, in which 0.5% v/v Nimbus was added.

### Example 29

### Summary of Three Tests to Assess the Efficacy of BF in 488 in the Control of Spots in Irrigated Rice Crops, Pelotas/RS, 2009/2010 Crop

This study was conducted to evaluate the efficacy of the prodcuts in the control of leaf spots in irrigated rice crops. Preventive fungicide applications occurred during the booting stage of rice, with 1 to 5% of panicles issued, with the second application occurring 15 days after the first and the third application taking place 15 days after the second application. Product BF 488 (tebuconazole 100+carbendazim 200+azoxystrobin 30); product BF 489 (flutriafol 62.5+carbendazim 200+azoxystrobin 30); product BF 452 (tebuconazole 100+carbendazim 200+kresoxim-methyl 125) and product BF 465 (flutriafol 62.5+carbendazim 200+kresoxim-methyl 125) are effective in controlling leaf spots (Table 26) providing excellent residual control that can be observed by the smaller area under the disease-progress curve. The efficacy of BF 488, BF 489, BF 452 and BF 465 is consistent, reducing the disease throughout the rice plant canopy. Disease severity was high as can be observed in the untreated control by the large area under the disease-progress curve, which resulted in lower productivity.

TABLE 26
Area under the disease-progress curve (AUDPC)—Summary
of three tests to assess the efficacy of BF 488 in the control of
spots in irrigated rice crops, Pelotas/RS.

| | | Doses/há | | | |
|---|---|---|---|---|---|
| | Tratamentos | G AI | Formulado | AUDPC | |
| 9 | BRIO | 187.5 | 0.75 | 29 | f |
| 3 | BF 375-01 + Derosal + Stroby + OM | 62.5 + 200 + 125 | 0.5 + 0.4 + 0.25 | 37 | e |
| 4 | BF 489 + OM | 292.5 | 1 | 40 | cde |
| 5 | BF 452-07 + OM | 425 | 1 | 40 | de |
| 6 | FOLICUR + Derosal + Stroby + OM | 100 + 200 + 125 | 0.5 + 0.4 + 0.25 | 46 | bcd |
| 8 | BF 465-05 + OM | 290 | 0.75 | 46 | bcd |
| 7 | BF 488 + OM | 330 | 1 | 47 | be |
| 2 | BF 465-05 + OM | 387.5 | 1 | 50 | b |
| 10 | FOLICUR + OM | 100 | 0.5 | 50 | b |
| 1 | UNTREATED | | | 172 | a |

| | |
|---|---|
| LSD (P = .05) | 7.0 |
| Standard Deviation | 2.7 |
| CV | 1.46 |

### Example 30

### Summary of Two Tests to Assess the Efficacy of BF 488, BF 489, BF 452 and BF 465 in the Control of Spots in Upland Rice Crops, São DesidéRio/BA and Sinop/MT, 2009/2010 Crop

These studies were conducted to evaluate the efficacy of the prodcuts in the control of leaf spots in upland rice crops. Preventive fungicide applications occurred during the booting stage of rice, with 1 to 5% of panicles issued, with the second application occurring 15 days after the first and the third application taking place 15 days after the second application. Product BF 488 (tebuconazole 100+carbendazim 200+azoxystrobin 30); product BF 489 (flutriafol 62.5+carbendazim 200+azoxystrobin 30); product BF 452 (tebuconazole 100+carbendazim 200+kresoxim-methyl 125); and product BF 465 (flutriafol 62.5+carbendazim 200+kresoxim-methyl 125) are effective in controlling leaf spots—rice blast (Tables 27 and 28), providing excellent residual control that can be observed by the lower severity of the rice blast. The efficacy of BF 488, BF 489, BF 452 and BF 465 is consistent, reducing the disease throughout the rice plant canopy and improving the health of panicles. Disease severity was high as can be observed in the untreated control by the high severity, which resulted in lower productivity.

Products BF 488, BF 489, BF 452 and BF 465 are effective in improving rice productivity.

TABLE 27
Severity of rice blast (Pyricularia grisea)-Study
carried out to assess the efficacy of BF 488, BF 489, BF 452 and BF 465 in
the control of spots in upland rice crops, Sinop/MT.

| Trt | Treatment | Rate | | Pyricularia grisea-Severity (%) | | | | | | Productivity | |
|---|---|---|---|---|---|---|---|---|---|---|---|
| No. | Name | a.i. g/ha | PC L/ha | 14DA2A | | 7DA3A | | 14DA3A | | kg ha⁻¹ | |
| 1 | UNTREATED | | | 26.3 | a | 31.3 | a | 42.5 | a | 1882.2 | c |
| 2 | BF 465-05 | 62.5 + 200 + 125 | 1 | 5.5 | b | 10.0 | c | 16.3 | d | 3194.4 | a |
| 3 | BF 489-03 | 62.5 + 200 + 30 | 1 | 6.5 | b | 11.8 | bc | 18.8 | bcd | 3000.0 | ab |
| 4 | ProductX | | | 5.0 | bc | 13.8 | b | 21.3 | bc | 2994.4 | ab |
| 5 | BF 452-07 | 100 + 200 + 125 | 1 | 3.8 | cd | 9.8 | c | 16.3 | d | 3000.0 | ab |
| 6 | BF 488-01 | 100 + 200 + 30 | 1 | 5.5 | b | 13.8 | b | 21.3 | bc | 3033.3 | ab |
| 7 | ProductY | | | 6.3 | b | 12.5 | bc | 22.5 | b | 2833.3 | ab |
| 8 | PRIORI XTRA | 24 + 60 | 0.3 | 5.3 | b | 13.8 | b | 20.0 | bcd | 2905.6 | ab |
| 9 | BRIO + DASH | (94 + 94) + 0.25% | 0.75 + 0.25% | 3.5 | d | 5.3 | d | 7.8 | e | 3183.3 | a |
| 10 | FOLICUR | 100 | 0.5 | 6.3 | b | 10.0 | c | 16.3 | d | 2400.0 | bc |
| 11 | OPERA | 25 + 66.5 | 0.5 | 6.5 | b | 11.3 | bc | 17.5 | bc | 2911.1 | ab |

| | | | | |
|---|---|---|---|---|
| LSD (P = .05) | 1.34 | 2.85 | 3.4 | 580.922 |
| CV | 12.7 | 15.2 | 11.76 | 14.12 |

*Adição de Assist 0.5% em todos os tratamentos, exceto o trtamento 8 (adição de Nimbus 0.5%) e trat 9

TABLE 28
Severity of rice blast (Pyricularia grisea)-Study
carried out to assess the efficacy of BF 488, BF 489, BF 452 and BF 465 in
the control of spots in upland rice crops, São Desidério-BA.

| | | | | Pyricularia grisea | | | | | | | | | |
|---|---|---|---|---|---|---|---|---|---|---|---|---|---|
| Trt | Treatment | Rate | | Severity (%) | | | | Incidence (%)-panicula | | | | Productivity | |
| No. | Name | a.i. g/ha | PC L/ha | 7DA2A | | 14DA2A | | 7DA2A | | 14DA2A | | kg ha⁻¹ | |
| 1 | UNTREATED | | | 17.5 | a | 30.0 | a | [symbol] | a | 7.8 | a | 1366.7 | e |
| 2 | BF 465-05 | 62.5 + 200 + 125 | 1 | 5.5 | c | 8.5 | cd | 3.2 | bc | 3.8 | bc | 2466.7 | b |
| 3 | BF 489-03 | 62.5 + 200 + 30 | 1 | 5.3 | c | 9.3 | cd | 2.4 | cd | 2.8 | bcd | 2083.3 | c |
| 4 | ProductX | | | 4.5 | c | 7.3 | d | 0.4 | e | 1.6 | d | 2096.7 | c |
| 5 | BF 452-07 | 100 + 200 + 125 | 1 | 4.3 | c | 8.0 | d | 1.0 | e | 1.4 | d | 2536.7 | b |
| 6 | BF 488-01 | 100 + 200 + 30 | 1 | 5.3 | c | 9.8 | cd | 1.6 | de | 2.6 | cd | 2780.0 | a |
| 7 | ProductY | | | 6.5 | c | 11.0 | cd | 1.6 | de | 2.8 | bcd | 2433.3 | b |
| 8 | PRIORI XTRA | 24 + 60 | 0.3 | 7.5 | c | 11.8 | cd | 1.2 | de | 2.8 | bcd | 1846.7 | d |
| 9 | BIM 750 | 225 | 0.3 | 12.3 | b | 19.3 | b | 4.2 | b | 4.4 | b | 1876.7 | d |
| 10 | FOLICUR | 100 | 0.5 | 7.5 | c | 13.5 | c | 0.8 | e | 1.0 | d | 2050.0 | c |
| 11 | OPERA | 25 + 66.5 | 0.5 | 4.5 | c | 7.8 | d | 1.2 | de | 2.0 | d | 1836.7 | d |

| | | | | | |
|---|---|---|---|---|---|
| LSD (P = .05) | 3.16 | 4.55 | 1.14 | 1.59 | 154.078 |
| CV | 29.87 | 25.51 | 35.75 | 36.71 | 5.02 |

*Adição de Assist 0.5% em todos os tratamentos, exceto o trtamento 8 (adição de Nimbus 0.5%) [symbol]
indicates data missing or illegible when filed

### Example 31

### Efficacy of BF 489 and BF 465 in the Control of Ramularia areola in Cotton Crops, Luis Eduardo Magalhaes/BA, 2009/2010 Crop

The test was conducted in randomized blocks design, with four replications. This study was carried out in Luis Eduardo Magalhães-BA, in the 2009/2010 crop, in cultivar Delta Opal. The applications started 45 days after crop emergence (DAE) and the other applications occurred at 60, 75 and 90 DAE. The severity of ramularia was high and the productivity of the untreated control was 32% lower than that obtained in the best management practices with fungicides. Product BF 465 (flutriafol 62.5+carbendazim+200+kresoxim-methyl 125) and product BF 489 (flutriafol 62.5+carbendazim 200+azoxystrobin 30) are effective in controlling Ramularia areola (Table 29), providing excellent residual control that can be seen by the smaller area under the curve of disease progress. The efficacy of the synergistic mixtures BF 489 and BF 465 is consistent, reducing the disease throughout the cotton plant canopy and ensuring productivity gain.

TABLE 29
Area under the disease-progress curve (AUDPC) and
yield in function of the interactions of fungicides for the control of Ramularea
areola in cotton crops, Luis Eduardo Magalhães-BA.

| | | | | | | | | | AUDPC | | | | | | Produc- | |
|---|---|---|---|---|---|---|---|---|---|---|---|---|---|---|---|---|
| Trt | Treatment Name/ApplicationTime | | | | Rate (g ha⁻¹ a.i.) | | | | LEALOW | | LEAMID | | LEAUPP | | tivity | |
| No. | 45DAE | 60DAE | 75DAE | 90DAE | 45DAE | 60DAE | 75DAE | 90DAE | C | | C | | C | | kg/ha | |
| 1 | UN- | | | | | | | | 498 | a | 1544 | a | 971 | a | 2071.8 | b |
| | TREATED | | | | | | | | | | | | | | | |
| 2 | PRIORI | EMIN. + | EMINENT + | EMIN. + | 75 | 50 + | 50 + | 50 + | 1711 | d | 778 | fg | 353 | h | 2843.2 | a |
| | | PORT. | PRIORI | PORT. | | 400 | 50 | 400 | | | | | | | | |
| 3 | PRIORI | PRIORI | PRIORI | PRIORI | 75 | 84 | 84 + | 84 | 1798 | bcd | 865 | d-g | 365 | gh | 2822.9 | a |
| | | XTRA | XTRA + | XTRA | | | 400 | | | | | | | | | |
| | | | PORTERO | | | | | | | | | | | | | |
| 4 | PRIORI | EMINENT + | EMINENT + | EMINENT | 84 | 50 + | 50 + | 50 | [symbol] | e | 233 | h | 178 | i | 3047.2 | a |
| | XTRA | MERTIN | PRIORI | | | 240 | 50 | | | | | | | | | |
| 5 | BF 465-05 | BF 465-05 | BF 465-05 | BF 465-05 | 388 | 388 | 388 | 388 | 1829 | bcd | 894 | c-f | 463 | c-f | 2856.9 | a |
| 6 | BF 465-05 | EMIN. + | BF 465-05 | EMIN. + | 388 | 50 + | 388 | 50 + | 1846 | bcd | 806 | efg | 382 | fgh | 2903.5 | a |
| | | PORT. | | PORT. | | 250 | | 250 | | | | | | | | |
| 7 | EMIN. + | BF 465-05 | EMIN. + | BF 465-05 | 50 + | 388 | 50 + | 388 | 1982 | b | 925 | cde | 418 | d-h | 2638.2 | a |
| | PORT. | | PORT. | | 250 | | 250 | | | | | | | | | |
| 8 | BF 465-05 | ATTRACT | BF 465-05 | ATTRACT | 388 | 313 | 388 | 313 | 1868 | bcd | 961 | cd | 494 | cd | 2911.7 | a |
| 9 | BF 465-05 | EMIN. + | BF 465-05 | ATTRACT | 388 | 50 + | 388 | 313 | 1929 | bc | 1001 | c | 536 | bc | 2788.4 | a |
| | | PORT. | | | | 250 | | | | | | | | | | |
| 10 | BF 489-03 | BF 489-03 | BF 489-03 | BF 489-03 | 293 | 293 | 293 | 293 | 1754 | cd | 930 | cde | 452 | def | 2596.5 | a |
| 11 | BF 489-03 | EMIN. + | BF 489-03 | EMIN. + | 293 | 50 + | 293 | 50 + | 1899 | bc | 763 | g | 396 | e-h | 2579.0 | a |
| | | PORT. | | PORT. | | 250 | | 250 | | | | | | | | |
| 12 | EMIN. + | BF 489-03 | EMIN. + | BF 489-03 | 50 + | 293 | 50 + | 293 | 1877 | bcd | 876 | c-g | 442 | d-g | 2661.2 | a |
| | PORT. | | PORT. | | 250 | | 250 | | | | | | | | | |
| 13 | BF 489-03 | ATTRACT | BF 489-03 | ATTRACT | 293 | 313 | 293 | 313 | 1982 | b | 1119 | b | 579 | b | 2643.1 | a |
| 14 | BF 489-03 | EMIN. + | BF 489-03 | ATTRACT | 293 | 50 + | 293 | 313 | 1772 | cd | 938 | cd | 468 | cde | 2700.7 | a |
| | | PORT. | | | | 250 | | | | | | | | | | |

| | | | | |
|---|---|---|---|---|
| LSD (P = .05) | 159.6 | 113.5 | 73.9 | 443.188 |
| CV | 6.19 | 8.8 | 11.15 | 11.41 |

[symbol]

indicates data missing or illegible when filed

### Example 32

### Efficacy of Tebuconazole+Carbendazim+Azoxystrobin in the Control of Ramularia areola in Cotton Crops. Santa Helena de Goiás/GO. 2008/2009 Crop

The test was conducted in randomized blocks design, with four replications. This study was carried out in Santa Helena de Goiás—GO, in the 2008/2009 crop, in cultivar Delta Opal. The applications started 45 days after crop emergence (DAE) and the other applications occurred at 60, 75 and 90 DAE. The severity of ramularia was high and the productivity of the untreated control was 36.5% lower than that obtained in the best management practices with fungicides. Product BF 452 (tebuconazole 100+carbendazim 200+kresoxim-methyl 125) and product tebuconazole 100+carbendazim 200+azoxystrobin 18 are effective in controlling Ramularia areola (Table 30), providing excellent residual control that can be seen by the smaller area under the curve of disease progress. The efficacy of the synergistic mixtures BF 452 and tebuconazole+carbendazim+azoxystrobin is consistent, reducing the disease throughout the cotton plant canopy and improving cotton productivity.

TABLE 30
Area under the disease-progress curve (AUDPC) and
yield in function of the interactions of fungicides for the control of Ramularea
areola in cotton crops, Santa Helena de Goiás-GO.

| Trt | | Rate | AUPDC | | | | | | Productivity | |
|---|---|---|---|---|---|---|---|---|---|---|
| No. | Treatment Name | a.i. g/ha⁻¹ | LEALOW | | LEAMID | | LEAUPP | | kg ha⁻¹ | |
| 1 | Check | | 4141.0 | a | 1960.0 | a | 531.0 | a | 2845.4 | b |
| 2 | BF 452-03 | 100 + 200 + 125 | 2266.3 | cd | 778.5 | c | 132.5 | c | 4375.0 | a |
| 3 | Folicur + Derosal + Stroby | 100 + 200 + 125 | 2293.8 | c | 718.5 | c | 132.5 | c | 4246.3 | a |
| 4 | Folicur + Derosal + Priori | 100 + 200 + 18 | 2166.3 | cd | 686.0 | c | 115.0 | c | 4437.4 | a |
| 5 | PrioriXtra | 84 | 2350.3 | c | 775.3 | c | 130.0 | c | 4254.8 | a |
| 6 | Opera | 91.5 | 2215.0 | cd | 750.0 | c | 125.0 | c | 4233.9 | a |
| 7 | Folicur | 100 | 2901.0 | b | 1077.5 | b | 226.0 | b | 3999.8 | a |

| | | | | |
|---|---|---|---|---|
| Tukey's HSD (P = .05) | 195.76 | 153.07 | 24.74 | 818.26 |
| CV (%) | 3.25 | 7.01 | 5.82 | 8.15 |

### Example 33

### Efficacy of BF 452 and BF 465 in the Control of Ramularia areola in Cotton Crops, Luis Eduardo Magalhaes/BA, 2008/2009 Crop

The test was conducted in randomized blocks design, with four replications. This study was carried out in Luis Eduardo Magalhães-BA, in the 2008/2009 crop, in cultivar Delta Opal. The applications started 45 days after crop emergence (DAE) and the other applications occurred at 60, 75 and 90 DAE. The severity of ramularia was high and the productivity of the untreated control was 36% lower than that obtained in the best management practices with fungicides. Product BF 465 (flutriafol 62.5+carbendazim 200+kresoxim-methyl 125) and BF 452 (tebuconazole 100+carbendazim 200+kresoxim-methyl 125) are effective in controlling Ramularia areola (Table 31), providing excellent residual control that can be seen by the smaller area under the curve of disease progress. The efficacy of the synergistic mixtures BF 452 and BF 465 is consistent, reducing the disease throughout the cotton plant canopy and ensuring productivity gain.

TABLE 31
Area under the disease-progress curve (AUDPC) and
yield in function of the interactions of fungicides for the control of Ramularea
areola in cotton crops, Luis Eduardo Magalhães-BA.

| | | | | | | | | | | | | | | | Produc- | |
|---|---|---|---|---|---|---|---|---|---|---|---|---|---|---|---|---|
| Trt | Treatment Name/Application Time | | | | Rate (g/ha i.a.) | | | | AACPD | | | | | | tivity | |
| No. | 45DAE | 60DAE | 75DAE | 90DAE | 45DAE | 60DAE | 75DAE | 90DAE | LEALOW | | LEAMID | | LEAUPP | | kg ha⁻¹ | |
| 1 | Check | Check | Check | Check | | | | | [symbol] | a | [symbol] | a | [symbol] | a | [symbol] | b |
| 2 | BF 465-03 | Idem | Idem | Idem | 62.5 + | Idem | Idem | Idem | 132.1 | def | 8.8 | c | 0.0 | b | [symbol] | ab |
| | | | | | 200 + | | | | | | | | | | | |
| | | | | | 125 | | | | | | | | | | | |
| 3 | ProductX | | | | | | | | [symbol] | ef | 0.0 | c | 0.0 | b | 2952.3 | ab |
| 4 | Flutriafol + | Idem | Idem | Idem | 62.5 + | Idem | Idem | Idem | [symbol] | f | 0.0 | c | 0.0 | b | 2886.5 | ab |
| | Derosal + | | | | 200 + | | | | | | | | | | | |
| | Priori | | | | 18 | | | | | | | | | | | |
| 5 | BF 452-03 | Idem | Idem | Idem | 100 + | Idem | Idem | Idem | 150.5 | c-f | 7.9 | c | 0.0 | b | 3129.1 | ab |
| | | | | | 200 + | | | | | | | | | | | |
| | | | | | 125 | | | | | | | | | | | |
| 6 | ProductY | | | | | | | | 187.3 | c-f | 13.1 | c | 0.0 | b | 2853.6 | ab |
| 7 | ProductZ | | | | | | | | 259.0 | cde | 17.5 | c | 0.0 | b | 2866.0 | ab |
| 8 | PrioriXtra | Idem | Idem | Idem | 84 | Idem | Idem | Idem | 162.8 | c-f | 12.3 | c | 0.0 | b | 2841.3 | ab |
| 9 | Opera | Idem | Idem | Idem | 91.5 | Idem | Idem | Idem | 134.8 | def | 0.0 | c | 0.0 | b | [symbol] | a |
| 10 | Folicur | Idem | Idem | Idem | 100 | Idem | Idem | Idem | 665.0 | b | 284.4 | b | 7.0 | b | 2878.3 | ab |
| 11 | Priori | Eminent + | Eminent + | Eminent + | 75 | 50 + | 50 + | 50 + | 359.6 | c | 100.6 | c | 0.0 | b | 3137.3 | ab |
| | | Derosal | Priori | Derosal | | 400 | 50 | 400 | | | | | | | | |
| 12 | Priori | PrioriXtra | PrioriXtra + | PrioriXtra | 75 | 84 | 84 + | 84 | 293.1 | cd | 52.5 | c | 0.0 | b | 2853.6 | ab |
| | | | Derosal | | | | 400 | | | | | | | | | |
| 13 | PrioriXtra | Eminent + | Priori + | Eminent | 84 | 50 + | 50 + | 50 | 114.6 | def | 0.0 | c | 0.0 | b | 2845.4 | ab |
| | | Mertin | Eminent | | | 240 | 50 | | | | | | | | | |

| | | | | |
|---|---|---|---|---|
| Tukey's HSD (P = .05) | 212.8 | 119.4 | 8.0 | 1032.8 |
| CV (%) | 28.1 | 56.9 | 148.7 | 13.9 |

[symbol]

indicates data missing or illegible when filed

### Example 34

### Efficacy of BF 452, BF 465 and Tebuconazole+Carbendazim+Azoxystrobin in the Control of Colletotrichum Gossypii Var. cephalosporioides in Cotton Crops, Santa Helena De Goiás/GO, 2008/2009 Crop

The test was conducted in randomized blocks design, with four replications. This study was carried out in Santa Helena de Goiás—GO, in the 2008/2009 crop, in cultivar BRS Ipê. The applications started 45 days after crop emergence (DAE) and two days after inoculation with a suspension of spores at the concentration of 105 conidia/mL. The other applications occurred at 60, 75 and 90 DAE. The severity of ramulosis was high and the productivity of the untreated control was 58.2% lower than that obtained in the best management practices with fungicides. Product BF 465 (flutriafol 62.5+carbendazim 200+kresoxim-methyl 125); BF 452 (tebuconazole 100+carbendazim 200+kresoxim-methyl 125) and product tebuconazole 100+carbendazim 200+azoxystrobin 18 are effective in controlling Colletotrichum gossypii var. cephalosporioides (Table 32), providing excellent residual control that can be seen by the lower disease score observed throughout the assessment. The efficacy of the synergistic mixtures BF 452, BF 465 and tebuconazole+carbendazim+azoxystrobin is consistent, reducing the disease in the cotton plants, which results in the maintenance of cotton productivity.

TABLE 32
Severity score (scale of 1 to 5) and productivity in
function of the interactions of fungicides in the control of Colletotrichum
gossypii var.cephalosporioides in cotton cross, Santa Helena de Goiás/GO.

| Trt | Treatment Name/Application Time | | | | Rate (g/ha i.a.) | | | |
|---|---|---|---|---|---|---|---|---|
| No. | 45DAE | 60DAE | 75DAE | 90DAE | 45DAE | 60DAE | 75DAE | 90DAE |
| 1 | Check | Check | Check | Check | | | | |
| 2 | BF 465-03 | Idem | Idem | Idem | 62.5 + | Idem | Idem | Idem |
| | | | | | 200 + 125 | | | |
| 3 | ProductX | | | | | | | |
| 4 | Flutriafol + | Idem | Idem | Idem | 62.5 + | Idem | Idem | Idem |
| | Derosal + | | | | 200 + 18 | | | |
| | Priori | | | | | | | |
| 5 | BF 452-03 | Idem | Idem | Idem | 100 + | Idem | Idem | Idem |
| | | | | | 200 + 125 | | | |
| 6 | ProductY | | | | | | | |
| 7 | ProductZ | | | | | | | |
| 8 | PrioriXtra | Idem | Idem | Idem | 84 | Idem | Idem | Idem |
| 9 | Opera | Idem | Idem | Idem | 91.5 | Idem | Idem | Idem |
| 10 | Folicur | Idem | Idem | Idem | 100 | Idem | Idem | Idem |
| 11 | Priori | Eminent + | Eminent + | Eminent + | 75 | 50 + | 50 + | 50 + |
| | | Derosal | Priori | Derosal | | 400 | 50 | 400 |
| 12 | Priori | PrioriXtra | PrioriXtra + | PrioriXtra | 75 | 84 | 84 + | 84 |
| | | | Derosal | | | | 400 | |
| 13 | PrioriXtra | Eminent + | Priori + | Eminent | 84 | 50 + | 50 + | 50 |
| | | Mertin | Eminent | | | 240 | 50 | |

Tukey's HSD (P = .05)
CV (%)

| | | | | | | | | | | | Produc- | |
|---|---|---|---|---|---|---|---|---|---|---|---|---|
| Trt | C. gossyppi (rate [symbol] 5) | | | | | | | | | | tivity | |
| No. | 16DA2A | | 15DA3A | | 10DA4A | | 20DA4A | | 30DA4A | | kg ha⁻¹ | |
| 1 | 1.2 | a | 4.3 | a | 4.5 | a | [symbol] | a | [symbol] | a | [symbol] | b |
| 2 | 1.0 | b | 1.0 | b | 1.2 | b | 1.1 | b | 1.2 | b | 3059.0 | a |
| 3 | 1.0 | b | 1.0 | b | 1.3 | b | 1.6 | b | 1.4 | b | 2868.4 | a |
| 4 | 1.0 | b | 1.0 | b | 1.0 | b | 1.0 | b | 1.0 | b | 2993.7 | a |
| 5 | 1.0 | b | 1.0 | b | 1.1 | b | 1.0 | b | 1.0 | b | 3320.8 | a |
| 6 | 1.0 | b | 1.0 | b | 1.0 | b | 1.0 | b | 1.0 | b | 2971.3 | a |
| 7 | 1.0 | b | 1.0 | b | 1.3 | b | 1.0 | b | 1.0 | b | 3261.6 | a |
| 8 | 0.0 | b | 1.0 | b | 1.2 | b | 1.3 | b | 1.4 | b | 3371.9 | a |
| 9 | 1.3 | b | 1.3 | b | 1.5 | b | 1.4 | b | 1.6 | b | 2926.6 | a |
| 10 | 4.1 | a | 4.2 | a | [symbol] | a | 3.7 | a | 1.2 | a | 1899.3 | b |
| 11 | 1.0 | b | 1.0 | b | 1.2 | b | 1.3 | b | 1.3 | b | 3058.6 | a |
| 12 | 1.2 | b | 1.2 | b | 1.6 | b | 1.6 | b | 1.7 | b | 3247.0 | a |
| 13 | 1.1 | b | 1.1 | b | 1.8 | b | 1.8 | b | 1.9 | b | 3522.4 | a |

| | | | | | | |
|---|---|---|---|---|---|---|
| Tukey's HSD | 0.529 | 0.46 | 0.9 | 1.06 | 0.89 | 730.41 |
| (P = .05) | | | | | | |
| CV (%) | 13.88 | 12 | 20.85 | 24.63 | 19.9 | 9.96 |

[symbol]

indicates data missing or illegible when filed

### Example 35

### Efficacy of BF 465 and BF 489 in the Control of Colletotrichum gossypii Var. Cephalosporioides in Cotton Crops, Santa Helena de Goiás/GO, 2009/2010 Crop

The test was conducted in randomized blocks design, with four replications. This study was carried out in Santa Helena de Goiás—GO, in the 2009/2010 crop, in cultivar BRS Ipê. The applications started 45 days after crop emergence (DAE) and two days after inoculation with a suspension of spores at the concentration of 105 conidia/mL. The other applications occurred at 60, 75 and 90 DAE. The severity of ramulosis was high in the experiment. Product BF 465 (flutriafol 62.5+carbendazim 200+kresoxim-methyl 125) and Product BF 489 (flutriafol 62.5+carbendazim 200+azoxystrobin 30) are effective in controlling Colletotrichum gossypii var. cephalosporioides (Table 33), providing excellent residual control that can be seen by the lower disease score observed throughout the assessment. The efficacy of the synergistic mixtures BF 489 and BF 465 is consistent, reducing the disease in the cotton plants, which results in the maintenance of cotton productivity.

TABLE 32
Severity score (scale of 1 to 5) and productivity in
function of the interactions of fungicides in the control of Colletotrichum
gossypii var.cephalosporioides in cotton crops, Santa Helena de Goiás/GO.

| Trt | | | | | | | | | | | | | | | Height | |
|---|---|---|---|---|---|---|---|---|---|---|---|---|---|---|---|---|
| | Treatment Name/Aplication time | | | | Rate (g ha⁻¹ a.i.) | | | | C. gossypii-Scale 1 to 5 | | | | | | (cm) | |
| No. | 45DAE | 60DAE | 75DAE | 90DAE | 45DAE | 60DAE | 75DAE | 90DAE | 14DA3A | | 7DA4A | | 35DA4A | | 35DA4A | |
| 1 | UN- | | | | | | | | [symbol] | a | 4.2 | a | 3.1 | a | 76.9 | c |
| | TREATED | | | | | | | | | | | | | | | |
| 2 | PRIORI | EMIN. + | EMINENT + | EMIN. + | 75 | 50 + 400 | 50 + 50 | 50 + 400 | 1.3 | bc | 1.5 | b | 1.1 | b | 90.8 | b |
| | | PORT. | PRIORI | PORTEIRO | | | | | | | | | | | | |
| 3 | PRIORI | PRIORI | PRIORI XTRA + | PRIORI | 75 | 84 | 84 + 400 | 84 | 1.0 | c | 1.3 | b | 1.2 | b | 93.6 | ab |
| | | XTRA | PORTERO | XTRA | | | | | | | | | | | | |
| 4 | PRIORI | EMINENT + | EMINENT + | EMINENT | 84 | 50 + 240 | 50 + 50 | 50 | 1.3 | bc | 1.5 | b | 1.1 | b | 92.1 | ab |
| | XTRA | MERTIN | PRIORI | | | | | | | | | | | | | |
| 5 | BF 465-05 | BF 465-05 | BF 465-05 | BF 465-05 | 388 | 388 | 388 | 388 | 1.5 | bc | 1.2 | b | 1.1 | b | 98.1 | ab |
| 6 | BF 465-05 | EMIN. + | BF 465-05 | EMIN. + | 388 | 75 + 325 | 388 | 75 + 325 | 1.4 | bc | 1.2 | b | 1.1 | b | 100.0 | ab |
| | | PORT. | | PORT. | | | | | | | | | | | | |
| 7 | EMIN. + | BF 465-05 | EMIN. + | BF 465-05 | 75 + 325 | 388 | 75 + 325 | 388 | 1.5 | bc | 1.3 | b | 1.0 | b | 97.0 | ab |
| | PORT. | | PORT. | | | | | | | | | | | | | |
| 8 | BF 465-05 | ATTRACT | BF 465-05 | ATTRACT | 388 | 500 | 388 | 500 | 1.5 | bc | 1.5 | b | 1.0 | b | 99.6 | ab |
| 9 | BF 465-05 | EMIN. + | BF 465-05 | ATTRACT | 388 | 75 + 325 | 388 | 500 | 1.0 | c | 1.5 | b | 1.1 | b | 100.1 | ab |
| | | PORT. | | | | | | | | | | | | | | |
| 10 | BF 489-03 | BF 489-03 | BF 489-03 | BF 489-03 | 293 | 293 | 293 | 293 | 1.6 | bc | 1.6 | b | 1.1 | b | 101.3 | a |
| 11 | BF 489-03 | EMIN. + | BF 489-03 | EMIN. + | 293 | 75 + 325 | 293 | 75 + 325 | 1.7 | bc | 1.3 | b | 1.1 | b | 101.4 | a |
| | | PORT. | | PORT. | | | | | | | | | | | | |
| 12 | EMIN. + | BF 489-03 | EMIN. + | BF 489-03 | 75 + 325 | 293 | 75 + 325 | 293 | 1.4 | bc | 1.5 | b | 1.0 | b | 96.6 | ab |
| | PORT. | | PORT. | | | | | | | | | | | | | |
| 13 | BF 489-03 | ATTRACT | BF 489-03 | ATTRACT | 293 | 500 | 293 | 500 | 1.4 | bc | 1.4 | b | 1.5 | b | 95.3 | ab |
| 14 | BF 489-03 | EMIN. + | BF 489-03 | ATTRACT | 293 | 75 + 325 | 293 | 500 | 1.8 | b | 1.2 | b | 1.1 | b | 96.4 | ab |
| | | PORT. | | | | | | | | | | | | | | |

| | | | | |
|---|---|---|---|---|
| LSD (P = .05) | 0.6 | 0.54 | 0.53 | 8.22 |
| CV | 26.46 | 24.31 | 29.78 | 6.02 |

[symbol]

indicates data missing or illegible when filed

### Example 36

### Summary of Two Studies—Efficacy of BF 465 and BF 452 in the Control of Coffee Rust (Hemileia vastatrix) in Coffee Crops, Espirito Santo do Pinhal/SP, 2009/2010 Crop

The tests were conducted in randomized blocks design, with four replications. They were carried out in Espirito Santo do Pinhal-SP in the 2009/2010 crop. The severity of rust was high in the experiment. Product BF 465 (flutriafol 62.5+carbendazim 200+kresoxim-methyl 125) and BF 452 (tebuconazole 100+carbendazim 200+kresoxim-methyl 125) are effective in controlling coffee leaf rust (Table 34) and Ascochyta spot (Table 35), providing excellent residual control that can be observed by the lower severity of the disease, the smaller area under the disease-progress curve and lower defoliation. The efficacy of the synergistic mixtures BF 452 and BF 465 is consistent, reducing the disease in the coffee plants, which results in the maintenance of coffee productivity.

TABLE 34
Summary of two studies-Efficacy of BF 465 and BF
452 in the control of coffee rust (Hemileia vastatrix) in coffee crops, Espirito
Santo do Pinhal/SP.

| | | Dose | | % Severidade | | | | | |
|---|---|---|---|---|---|---|---|---|---|
| | Tratamentos | g.i.a/há | ml/há | 15 DAT | 30 DAT | 45 DAT | 60 DAT | AUDPC | % Desfolha |
| 1. | Testemunha | | | 13 | 33 | 41 | 47.5 | 1649 | 59.38 |
| 2. | BF452-03 | 850 | 2 | 0 | 0 | 0.94 | 2 | 33.06 | 1.63 |
| 3. | BF452-03 | 1060 | 2.5 | 0 | 0 | 0.38 | 1.63 | 20.69 | 1.63 |
| 4. | BF452-03 | 1280 | 3 | 0 | 0 | 0.38 | 0.75 | 12.75 | 1.5 |
| 5. | BF465-05 | 775 | 2 | 0 | 0 | 0.38 | 3 | 34.88 | 1.75 |
| 6. | 8F465-05 | 970 | 2.5 | 0 | 0 | 0.38 | 1.13 | 17.06 | 1.5 |
| 7. | BF465-05 | 1160 | 3 | 0 | 0 | 0 | 1.13 | 10.69 | 1 |
| 8. | Opera + Cantus | 275 + 75 | 1.5 + 0.15 | 0 | 0 | 0.38 | 1.19 | 16.53 | 1.63 |
| 9. | Opera | 275 | 1.5 | 0 | 0 | 0.56 | 1.19 | 19.34 | 1.75 |
| 10. | Impact 125 | 188 | 1.5 | 0 | 0 | 0.81 | 1.81 | 29.03 | 1.88 |

TABLE 35
Summary of two studies—Efficacy of BF 465 and
BF 452 in the control of Ascochyta spot in coffee
crops, Espirito Santo do Pinhal/SP.

| | Dose | | |
|---|---|---|---|
| Tratamentos | g.i.a/há | ml/há | % Severidade |
| 1.Testemunha | | | 18.75 |
| 2.BF452-03 | 850 | 2 | 3.13 |
| 3.BF452-03 | 1060 | 2.5 | 2 |
| 4.BF452-03 | 1280 | 3 | 1.38 |
| 5.BF465-05 | 775 | 2 | 4 |
| 6.BF465-05 | 970 | 2.5 | 1.5 |
| 7.BF465-05 | 1160 | 3 | 1.75 |
| 8.Opera + Cantus | 275 + 75 | 1.5 + 0.15 | 2.25 |
| 9.Opera | 275 | 1.5 | 1.88 |
| 10.Impact 125 | 188 | 1.5 | 2.38 |

1. An agrochemically synergistic formulation, characterized by comprising:
(i) triazole;
(ii) strobilurin;
(iii) benzimidazole, and
(iv) suitable adjuvants, carriers and/or excipients;
wherein the ratio of (i):(ii):(iii) in the formulation is about 4-15:1-18:10-30, preferably about 6.25-10:3-12.5:20.

2. A formulation according to claim 1, characterized in that said triazole (i) is selected from the group consisting of tebuconazole, flutriafol and mixtures thereof.

3. A formulation according to claim 1, characterized in that said strobilurin (ii) is selected from the group consisting of azoxystrobin, kresoxim-methyl and mixtures thereof.

4. A formulation according to claim 1, characterized in that said benzimidazole (iii) is carbendazim.

5. The formulation according to claim 1, characterized in that it comprises:
about 25 to 250 g/L triazole (i), preferably about 63 to about 100 g/L;
about 5 to about 500 g/L strobilurin (ii), preferably about 30 to about 125 g/L; and
about 50 to about 500 g/L benzimidazole (iii), preferably about 200 g/L.

6. The formulation according to claim 1, characterized in that it comprises a total of about 10 to about 700 g/L of (i), (ii) and (iii).

7. The formulation according to claim 1, characterized in that the suitable adjuvants, carriers and/or excipients are selected from the group consisting of: water, surfactants, antifoaming agents, rheology modifiers, dispersing agents, moisturizers, bactericides or bacteriostatic agents, anti-caking agents, stabilizers, antifreezing agents, clays, silicates, silica, resins, waxes, cellulosic fibers, fertilizers, C1-C14 alcohols, glycols, acetates, ketones, glycerides, saturated or unsaturated hydrocarbons, fatty acid esters, vegetable oils, mineral oils, and mixtures thereof.

8. The formulation according to claim 1, characterized in that it is in the solid or liquid form, preferably the solid form is a wet powder (PM) and/or water-dispersed granules (WDG) and the liquid form is an emulsified concentrate (EC), concentrated suspension (SC), suspension-emulsion (SE) and/or concentrated emulsion (EW).

9. The formulation according to claim 1, characterized in that it comprises:

| (Components) | concentration (g/100 mL mL)] |
|---|---|
| Water | qsp |
| Silicon emulsion | 0.3 |
| EO/PO Copolymer | 4 |
| Polyalkylene glycol copolymer | 1.5 |
| with polyolefin with anhydrous | |
| Benzisotiazolin | 0.25 |
| Smectite clay | 0.35 |
| Monoethylene glycol | 7 |
| Xanthan gum | 0.25 |
| Carbendazim | 20 |
| Tebuconazole | 10 |
| Azoxystrobin | 3 |

10. The formulation according to claim 1, characterized in that it comprises:

| (Components) | [concentration (g/100 mL mL)] |
|---|---|
| Water | qsp |
| Silicon emulsion | 0.3 |
| EO/PO copolymer | 3 |
| Lignosulfonate | 2 |
| Isotridecyl alcohol with 12 | 1 |
| moles of ethene oxide | |
| Benzisotiazolin | 0.25 |
| Smectite clay | 0.35 |
| Propylenoglycol | 5 |
| Xanthan gum | 0.25 |
| Carbendazim | 20 |
| Tebuconazole | 10 |
| Azoxystrobin | 3 |

11. The formulation according to claim 1, characterized in that it comprises:

| (Components) | [concentration (g/100 mL mL)] |
|---|---|
| Water | qsp |
| Silicon emulsion | 0.3 |
| Tristyrylphenol phosphate with 16 | 3 |
| moles of neutralized ethene oxide | |
| Tristyrylphenol phosphate with 16 moles | 2 |
| of ethene oxide under the acid form | |
| Isotridecyl alcohol with 12 moles of | 1 |
| ethene oxide | |
| Benzisotiazolin | 0.25 |
| Smectite clay | 0.35 |
| Monoethylene glycol | 5 |
| Xanthan gum | 0.25 |
| Carbendazim | 20 |
| Tebuconazole | 10 |
| Azoxystrobin | 3 |

12. The formulation according to claim 1, characterized in that it comprises:

| (Components) | [concentration (g/100 mL mL)] |
|---|---|
| Water | qsp |
| Silicon emulsion | 0.3 |
| Tristyrylphenol phosphate with 16 | 4.5 |
| moles of neutralized ethene oxide | |
| Nonylphenol with 10 moles of ethene | 1.7 |
| oxide | |
| Benzisotiazolin | 0.25 |
| Bentonite clay | 0.35 |
| Monoethylene glycol | 8.8 |
| Xanthan gum | 0.25 |
| Carbendazim | 20 |
| Tebuconazole | 10 |
| Azoxystrobin | 3 |

13. The formulation according to claim 1, characterized in that it comprises:

| (Components) | [concentration (g/100 mL mL)] |
|---|---|
| Water | qsp |
| Silicon emulsion | 0.3 |
| Tristyrylphenol phosphate with 16 | 4 |
| moles of neutralized ethene oxide | |
| Isotridecyl alcohol with 12 moles | 1.5 |
| of ethene oxide | |
| Benzisotiazolin | 0.25 |
| Bentonite clay | 0.35 |
| Monoethylene glycol | 5 |
| Xanthan gum | 0.25 |
| Carbendazim | 20 |
| Flutriafol | 6.25 |
| Azoxystrobin | 3 |

14. The formulation according to claim 1, characterized in that it comprises:

| (Components) | [concentration (g/100 mL mL)] |
|---|---|
| Water | qsp |
| Silicon emulsion | 0.3 |
| Block copolymer of ethene | 4 |
| oxide and propene oxide | |
| Acrylic copolymer | 1.5 |
| Benzisotiazolin | 0.25 |
| Bentonite clay | 0.35 |
| Monoethylene glycol | 5 |
| Xanthan gum | 0.25 |
| Carbendazim | 20 |
| Flutriafol | 6.25 |
| Azoxystrobin | 3 |

15. The formulation according to claim 1, characterized in that it comprises:

| (Components) | [concentration (g/100 mL mL)] |
|---|---|
| Water | qsp |
| Silicon emulsion | 0.3 |
| Block copolymer of ethene | 4 |
| oxide and propene oxide | |
| Methyl metacrylate copolymer | 1.5 |
| Benzisotiazolin | 0.25 |
| Bentonite clay | 0.35 |
| Monoethylene glycol | 5 |
| Xanthan gum | 0.25 |
| Carbendazim | 20 |
| Flutriafol | 6.25 |
| Azoxystrobin | 3 |

16. The formulation according to claim 1, characterized in that it comprises:

| (Components) | [concentration (g/100 mL mL)] |
|---|---|
| Water | qsp |
| Silicon emulsion | 0.3 |
| Tristyrylphenol phosphate with 16 | 4.5 |
| moles of neutralized ethene oxide | |
| Ethoxylated nonylphenol with 10 | 1.5 |
| moles of ethene oxide | |
| Benzisotiazolin | 0.25 |
| Bentonite clay | 0.35 |
| Monoethylene glycol | 9 |
| Xanthan gum | 0.25 |
| Carbendazim | 20 |
| Flutriafol | 6.25 |
| Azoxystrobin | 3 |

17. The formulation according to claim 1, characterized in that it comprises:

| (Components) | [concentration (g/100 mL mL)] |
|---|---|
| Water | qsp |
| Polydimethylsiloxane | 0.2 |
| Tristyrylphenol phosphate with 16 | 3.0 |
| moles of neutralized ethene oxide | |
| Ethoxylated isotridecyl alcohol with | 1.0 |
| 6 moles of ethene oxide | |
| Benzisotiazolin | 0.25 |
| Monoethylene glycol | 5.0 |
| Xanthan gum | 0.35 |
| Carbendazim | 20 |
| Flutriafol | 6.25 |
| Krezoxim-methyl | 12.5 |

18. The formulation according to claim 1, characterized in that it comprises:

| (Components) | [concentration (g/100 mL mL)] |
|---|---|
| Water | qsp |
| Polydimethylsiloxane | 0.2 |
| Block copolymer of ethene | 3.0 |
| oxide and propene oxide | |
| Acrylic copolymer | 1.0 |
| Benzisotiazolin | 0.25 |
| Monoethylene glycol | 5.0 |
| Xanthan gum | 0.35 |
| Carbendazim | 20 |
| Flutriafol | 6.25 |
| Krezoxim-methyl | 12.5 |

19. The formulation according to claim 1, characterized in that it comprises:

| (Components) | [concentration (g/100 mL mL)] |
|---|---|
| Water | qsp |
| Polydimethylsiloxane | 0.2 |
| Block copolymer of ethene | 3.0 |
| oxide and propene oxide | |
| Methyl metacrylate copolymer | 1.0 |
| Benzisotiazolin | 0.25 |
| Monoethylene glycol | 5.0 |
| Xanthan gum | 0.35 |
| Carbendazim | 20 |
| Flutriafol | 6.25 |
| Krezoxim-methyl | 12.5 |

20. The formulation according to claim 1, characterized in that it comprises:

| (Components) | [concentration (g/100 mL mL)] |
|---|---|
| Water | qsp |
| Polydimethylsiloxane | 0.2 |
| Block copolymer of ethene oxide | 3.0 |
| and propene oxide | |
| Methyl metacrylate copolymer | 1.0 |
| Benzisotiazolin | 0.25 |
| Monoethylene glycol | 5.0 |
| Xanthan gum | 0.35 |
| Carbendazim | 20 |
| Tebuconazole | 10 |
| Krezoxim-methyl | 12.5 |

21. The formulation according to claim 1, characterized in that it comprises:

| (Components) | [concentration (g/100 mL mL)] |
|---|---|
| Water | qsp |
| Polydimethylsiloxane | 0.2 |
| Tristyrylphenol phosphate with 16 | 3.0 |
| moles of neutralized ethene oxide | |
| Ethoxylated isotridecyl alcohol | 1.0 |
| with 6 moles of ethene oxide | |
| Benzisotiazolin | 0.25 |
| Monoethylene glycol | 9.0 |
| Xanthan gum | 0.35 |
| Carbendazim | 20 |
| Tebuconazole | 10 |
| Krezoxim-methyl | 12.5 |

22. The formulation according to claim 1, characterized in that it comprises:

| (Components) | [concentration (g/100 mL mL)] |
|---|---|
| Water | qsp |
| Silicon emulsion | 0.5 |
| Tristyrylphenol phosphate with 54 | 3.0 |
| moles of neutralized ethene oxide | |
| Ethoxylated lauryl alcohol with 7 | 1.0 |
| moles of ethene oxide | |
| Benzisotiazolin | 0.25 |
| Monoethylene glycol | 7.0 |
| Xanthan gum | 0.30 |
| Carbendazim | 20 |
| Tebuconazole | 10 |
| Krezoxim-methyl | 12.5 |

23. A process for preparing an agrochemically synergistic formulation as defined in claim 1, characterized by comprising the steps of:
a. Mixing in a container the suitable adjuvants, carriers and/or excipients;
b. Adding to mixture “a” above, under agitation, the triazole (i) the strobilurin (ii) and benzimidazole (iii) at a ratio of about 4-15:1-18:10-30, respectively;
c. Obtaining the agrochemically synergistic formulation; and
d. Packing it into commercial packages.

24. Use of triazole, strobilurin and benzimidazole, characterized by being in the preparation of an agrochemically synergistic formulation for controlling and/or combating plagues and diseases caused therefrom in vegetable cultures.

25. Use of the agrochemically synergistic formulation as defined in claim 1, or obtained by the process comprising the steps of:
a. Mixing in a container the suitable adjuvants, carriers and/or excipients;
b. Adding to mixture “a” above, under agitation, the triazole (i) the strobilurin (ii) and benzimidazole (iii) at a ratio of about 4-15:1-18:10-30, respectively;
c. Obtaining the agrochemically synergistic formulation; and
d. Packing it into commercial packages;
wherein use of said agrochemically synergistic formulation is characterized by being for controlling and/or combating plagues and diseases caused therefrom in vegetable cultures.

26. The use according to claim 24, characterized in that the formulation is employed in a single, sequential or simultaneous application.

27. A method for controlling and/or combating plagues and diseases in vegetable cultures, characterized by comprising the application of an agrochemically synergistic formulation on their habitats and/or vegetable cultures, wherein said agrochemically synergistic formulation is defined in claim 1, or obtained by the process comprising the steps of:
a. Mixing in a container the suitable adjuvants, carriers and/or excipients;
b. Adding to mixture “a” above, under agitation, the triazole (i) the strobilurin (ii) and benzimidazole (iii) at a ratio of about 4-15:1-18:10-30, respectively;
c. Obtaining the agrochemically synergistic formulation; and
d. Packing it into commercial packages.

28. The method according to claim 27, characterized in that the cultures are selected from soybean, cotton, corn, beans, wheat, rice, potato, tomato, citrus and tobacco and the diseases are selected from Alternaria citri, Alternaria solani, Alternaria sp, Ascochyta coffeae, Ascochyta sojae, Bipolaris oryzae, Bipolaris sorokiniana, Blumeria graminis, Cercospora coffeicola, Cercospora kikuchii, Cercospora sojina, Cercospora zea-maydis, Colletotrichum coffeanum, Colletotrichum dematium var. truncata, Colletotrichum gloeosporioides, Colletotrichum gossypii var. cephalosporioides, Colletotrichum graminicola, Colletotrichum lindemuthianum, Corynespora cassiicola, Diaporthe phaseolorum f.sp. meridionalis, Diplodia macrospora, Drechslera tritici-repentis, Elsinoe fawcetti, Erysiphe diffusa, Erysiphe polygoni, Exerohilum turcicum, Hemileia vastatrix, Myrothecium roridum, Peronospora manshurica, Phaeoisariopsis griseola, Phaeosphaeria maydis, Phakopsora gossypii, Phakopsora meibomiae, Phakopsora pachyrhizi, Phoma spp., Phomopsis spp., Phyllosticta sojicola, Physopella zeae, Puccinia cacabata, Puccinia graminis, Puccinia polysora, Puccinia sorghi, Puccinia triticina, Pyricularia grisea, Ramularia areola, Rhizoctonia solani, S. macrospora, Sclerotinia sclerotiorum, Septoria glycines, Septoria lycopersici, Septoria tritici, Stenocarpella maydis, and Uromyces appendiculatus.

29. The method according to claim 27, characterized in that the formulation is employed in a single, sequential or simultaneous application.
